(19) United States
(12) Patent Application Publication
(10) Pub. No.: US 2017/0131874 A1
(43) Pub. Date: May 11, 2017

(54) Software Design Tool For A User Interface And The Administration Of Proximity Responsive Information Displays In Augmented Reality Or Virtual Reality Environments

(71) Applicant: LiveTiles LLC, New York, NY (US)

(72) Inventor: Karl Redenbach, New York, NY (US)

(21) Appl. No.: 14/935,872

(22) Filed: Nov. 9, 2015

(51) Int. Cl. G06F 3/0484; G06T 19/00; G06F 3/0486; G06F 3/0481; G06F 3/0482

(52) U.S. Cl. CPC G06F 3/04845; G06F 3/04817; G06F 3/0482; G06F 3/0486; G06T 19/006

(57) ABSTRACT

A method, computer program product, and system for creating and modifying an information display for an AR/VR environment, including for a display containing functional content to be responsive without the user needing to know any computer coding or web-development languages. The method, computer program product, and system allow the user to create a multitude of different tile arrangements and configurations through a simple user interface, and to position them so that they are responsive based on inputs such as apparent proximity of the viewer to the information display within the AR/VR environment or end-user gestures or verbal commands. The user's arrangement and configuration in the user interface are then interpreted and the corresponding code is implemented.

### BACKGROUND

Currently there are no software design tools that enable a non-technical user to create and modify custom and responsive design information displays in an augmented reality or virtual reality environment (“AR/VR environment”). Neither is there currently any application which utilizes drop and drag interaction to create custom and responsive design information displays in an AR/VR environment. Furthermore, there is no application that permits the editing of these information displays by both a user within an AR/VR environment as well as by a user outside of the AR/VR environment.

Prior to the current invention, the creation of an information display in an AR/VR environment would typically be conducted by a developer and/or designer using AR/VR environment development tools. These tools require specific technical knowledge and training, and are both time consuming and complicated to use.

Other systems can provide AR/VR information displays that are responsive, however, any modifications to that AR environment requires the same technical skills and knowledge.

### SUMMARY

The inventor has developed a system and method for users to create and modify an information display for an AR/VR environment, including for a display containing functional tiles to be responsive. It should be noted that throughout this specification the word “including” means “including but not limited to”.

A tile is a screen graphic in which information, images, or icon graphics can be displayed within a square, a circle, or any other shape. A tile may display animated or dynamic content in order to present different points of information. A tile may also be referred to as a label.

The systems and methods presented herein employ a software design tool permitting the user to easily change the content, responsiveness, and placement of tiles, without the user needing to know any computer coding or web-development languages including HTML, XAML, X3D, O3D, OpenGL, scripting mark-up languages, DirectX, JavaScript, C#, C++, or CSS. As used herein the word “tool” includes, but is not limited to, a computer implemented method, computer program product or a system.

The systems and methods presented herein can be used to create a responsive display within any type of AR/VR environment. A person of ordinary skill in the art will understand that the systems and method disclosed herein can be used in many types of AR/VR environments. The systems and methods are applicable to any AR/VR environment including Microsoft® HoloLens®, Oculus Rift®, Magic Leap Digital Lightfield®, or others.

The system and methods allow the user to create a multitude of different tile arrangements and configurations with the software design tool, and to position them so that they are responsive based on the apparent proximity of the viewer to the information display within the AR/VR environment. Additionally, the system and methods can provide out-of-the-box templates, greatly reducing the time and effort needed to build multiple responsive displays. The ability to create customizable tile configurations or to use pre-set templates allows for a better user experience while still providing flexibility in the design of the information display.

This summary is provided to introduce simplified concepts for using a software design tool for the user interface and administration of tiles for proximity responsive information displays within AR/VR environments. The concepts are further described below in the Detailed Description and/or shown in the Figures. This summary is not intended to identify essential features of the claimed subject matter, nor is it intended for use in determining the scope of the claimed subject matter. The term “techniques” as used herein can include devices, systems, apparatuses, components, operations, and/or methods as permitted by the context in which the term is used.

### BRIEF DESCRIPTION OF DRAWINGS

Examples of building a responsive information display for AR/VR environments using this system and methods are described with reference to the following drawings. The same numbers are used throughout the drawings to reference like features and components:

FIG. 1 illustrates the perspective of an end user in the AR/VR environment looking at a single display.

FIG. 2 illustrates the perspective of an end user in the AR/VR environment looking at multiple displays.

FIG. 3 illustrates the responsiveness of the information display to the apparent proximity of the end user.

FIG. 4 illustrates positioning information displays within the AR/VR environment.

FIG. 5 illustrates the architecture of the application and display design.

FIG. 6 illustrates the logic of the proximity responsiveness process.

FIG. 7 illustrates the hierarchy of the items that form the information display as constructed on the design canvas, and their makeup in code.

FIG. 8 illustrates accessing the responsive layout options in the application.

FIG. 9 illustrates adding a layout container to the responsive display canvas.

FIG. 10 illustrates adding a layout row to the responsive display canvas.

FIG. 11 illustrates adding another layout row to the responsive display canvas, within an existing row.

FIG. 12 illustrates selecting the Tile menu.

FIG. 13 illustrates adding a tile from the tile menu to the responsive display layout using drag and drop.

FIG. 14 illustrates adding a second tile from the tile menu to the responsive display layout using drag and drop.

FIG. 15 illustrates opening up a tile's configuration options.

FIG. 16 illustrates selecting layout options for a specific tile.

FIG. 17 illustrates using the tile configuration options to hide a tile for viewing at >15 meters apparent proximity.

FIG. 18 illustrates the result of hiding a tile at the >15 meters view.

FIG. 19 illustrates the 10-15 meters view, and the selection of the 5-10 meters view.

FIG. 20 illustrates the 5-10 meters view, and the selection of the <5 meters view.

FIG. 21 illustrates the <5 meters view.

FIG. 22 illustrates options for creating a new display.

FIG. 23 illustrates the design canvas with the Standard Tiles module box displayed.

FIG. 24 illustrates the design canvas and the administrative menu.

FIG. 25 illustrates a tile containing a delete function.

FIG. 26 illustrates opening a previously saved display.

FIG. 27 illustrates a close-up view of the Standard Tiles module box.

FIG. 28 illustrates the different tiles known as functional tiles.

FIG. 29 illustrates the concept of group tiles.

FIG. 30 illustrates configuring a tile.

### DETAILED DESCRIPTION

### Overview

This document describes techniques for a software design tool for a non-technical user to create a responsive design information display in an AR/VR environment. In a preferred embodiment, a system and method for a responsive information display is created using a mix of both columns and rows and utilizing a drag and drop approach. The systems and methods encompass other systems and methods for a user to create or modify a responsive display. Such other methods include but are not limited to using a component, icon, tab, or way to allow the user to change the design in a design view.

Furthermore, systems and methods are provided to enable users to modify or replace existing information display components and functions using a software design tool. This tool simplifies the process by which a user, without the knowledge of computer programming or coding, can create a responsive information display. A responsive information display is one that is able to dynamically adjust its layout and/or content based on the apparent proximity of the end user to the information display within the AR/VR environment. The complexity of coding such an information display is hidden from the user and exposed via the system.

Systems and apparatus for determining the location of the end user, or the proximity of the end user to the information display, within the AR/VR environment are well known to persons of ordinary skill in the art. One such system or apparatus is a Head Mounted Device (HMD) that contains one or more sensors that determines the location of the wearer through any variety of methods well known in the art. Examples of such HMDs can include those described in U.S. Patent Publication Nos. 20140139551 and 20140267420 which disclosures are incorporated by reference herein. However, the inventor contemplates other embodiments of the invention that will be readily discernible to a person of ordinary skill in the art.

The following is an illustrative example of a preferred embodiment of the invention, disclosing how using a software design tool for user interface and administration of responsive information displays in an AR/VR environment can be used across multiple systems and methods.

As used herein, the terms “component,” “system” and the like are intended to refer to a computer related entity. This includes but is not limited to hardware, a combination of hardware and software, software or software in execution. For example, a component may be, but is not limited to, a process running on a processor, a processor, an object, an executable, a thread of execution, a program, and/or a computer. By way of illustration, both an application running on a computer and the computer itself can be a component. One or more components may reside within a process and/or thread of execution and a component may be localized on one computer and/or be distributed between two or more computers.

In addition, the term “end-user” is used to refer to a user who is viewing the completed information display, as distinct from a user who is using the application to design the information display. For example, an end-user may be, but is not limited to, a person viewing the information display with or without having access to the design of the information display, a user who has completed designing the information display and wishes to see how the display will appear to an end user, and/or a person who is being shown the information display.

### Preferred Embodiment

A preferred embodiment of the system and method of the disclosed invention for implementing a responsive design canvas is disclosed below. The system and method can be used within a software application running on hardware including a desktop or laptop personal computer, mobile device, tablet, or AR/VR device. The system and method may also be used within a software application presented in a responsive information display within an AR/VR environment, for use by an end-user who is authorized to design and modify the AR/VR environment. Other embodiments of the disclosed invention are discernible by a person of ordinary skill in the art from the disclosure herein.

In a preferred embodiment the User Interface consists of a visual design canvas presented as a window within a software application. The design canvas allows the placement of components by the user, which are then implemented in the information display in response to a user's action. In the illustrative examples below the user action consists of dragging and dropping a layout component onto the information display, using for example a mouse, AR/VR control gestures, or any input device known to those of skill in the art. However, the disclosed systems and methods contemplate other types of user actions, including the use of drop down menus, selecting icons, using soft keys or using other techniques known to those of skill in the art. The logic controlling the behavior of the information display and the tiles within it are controlled by the user's interaction with the configuration options presented to them via the user interface, so that the user is not required to directly change the code that governs the appearance and behavior of the information display.

### Example Methods:

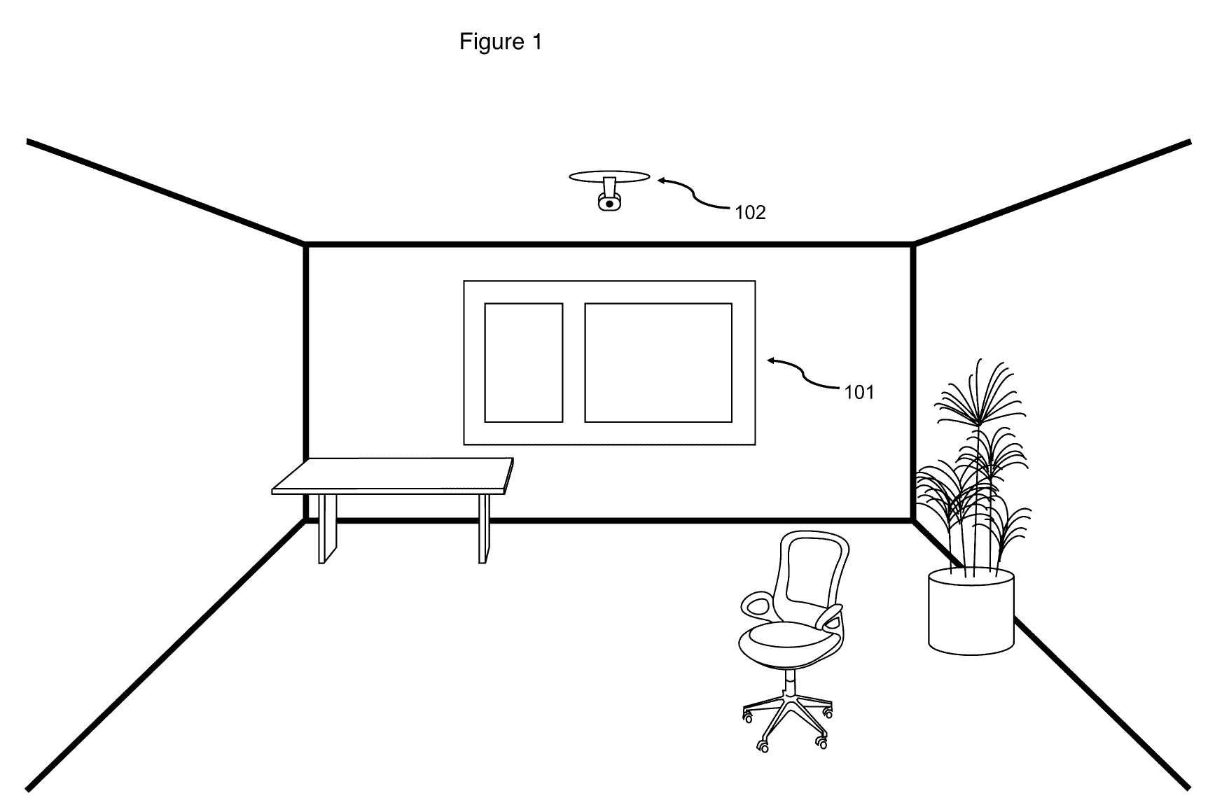

The illustrative example of FIG. 1 shows the perspective of an end user viewing a responsive information display 101 in an AR/VR environment. The end user may be equipped with goggles displaying AR/VR content, or the user's workspace may be equipped with a laser system 102 to project AR/VR content at the user. Either system will permit the image of the information display to shift according to the position of the user and the orientation of the user's head, so that the information display appears in three-dimensional space as a flat surface similar to a television set or computer display.

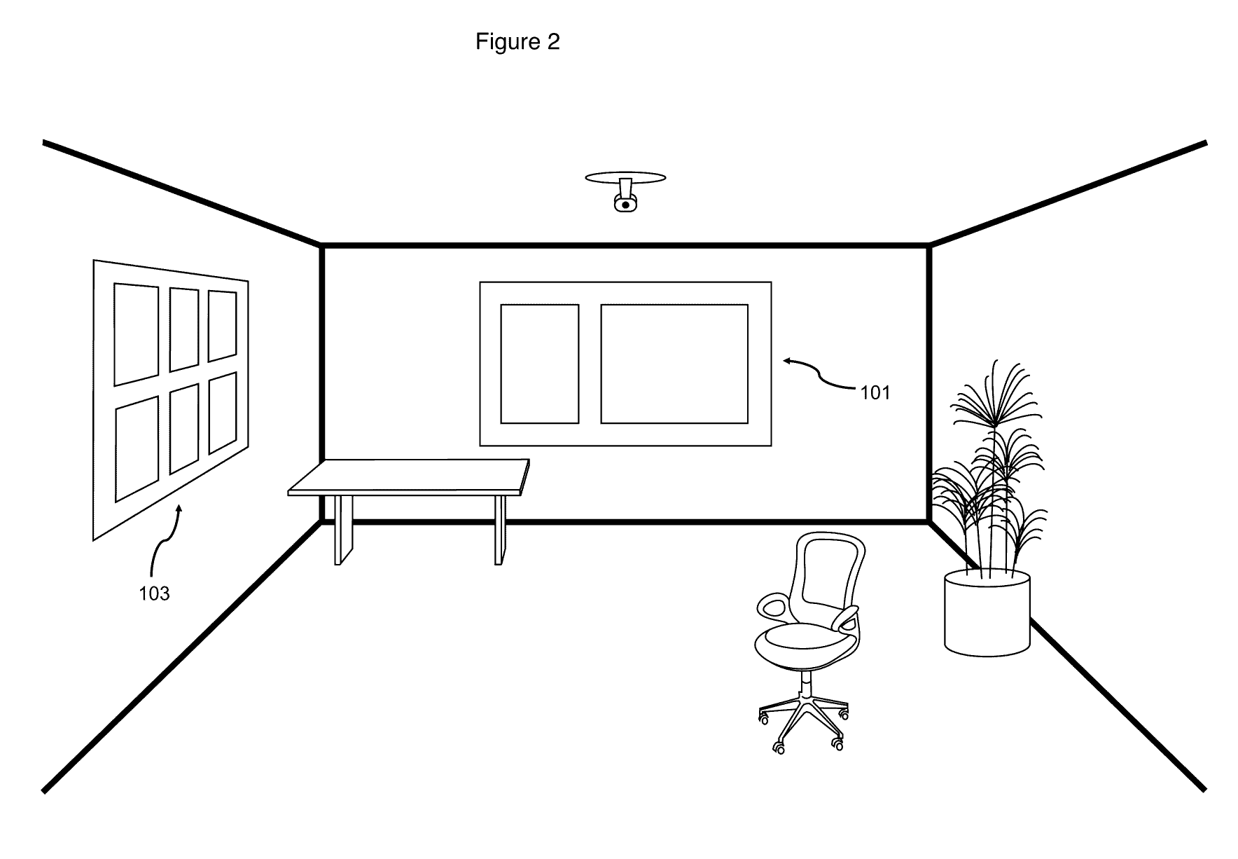

The illustrative example of FIG. 2 shows an end user viewing multiple responsive information displays in an AR/VR environment. Each information display is responsive, showing features, contents, and layouts that may vary according to the apparent proximity of the end user to the display within the AR/VR environment. In the illustrative example of FIG. 2, the display 103 closest to the end user shows a greater number of tiles in a more complex layout, while the display 101 at a greater apparent distance from the end user shows a lesser number of tiles in a simpler layout, in order to provide information at a level of detail, legibility, and ease of understanding appropriate to the scale of the information display.

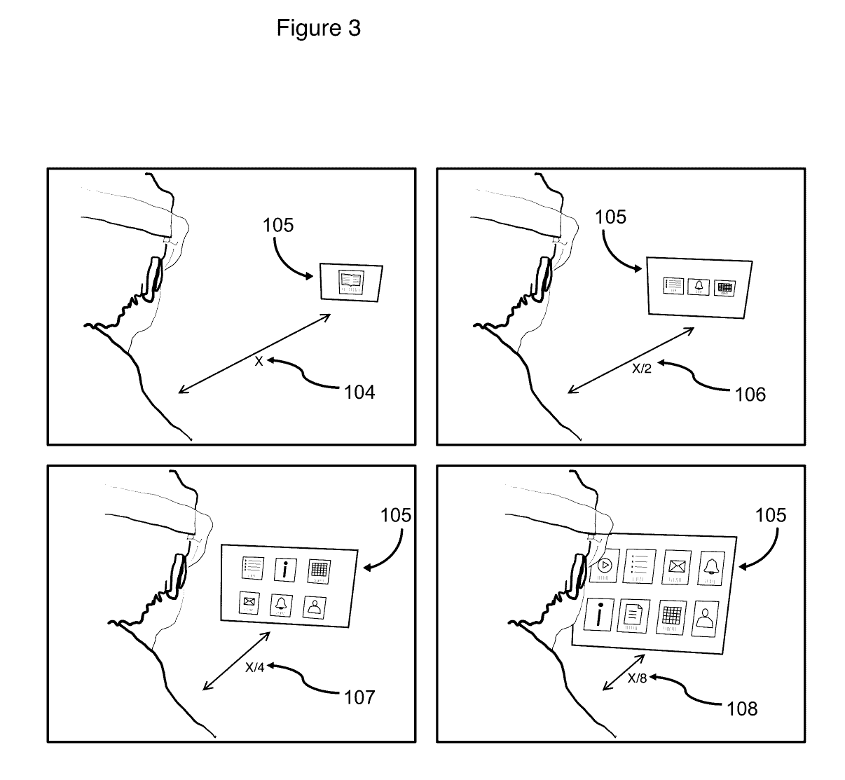

The illustrative example of FIG. 3 shows the responsive information display changing its features, contents, and/or layout as a function of the apparent proximity of the end user to the display within the AR/VR environment. In the illustrative example of FIG. 3, as the user comes closer to the responsive information display, the features, contents, and layout of the display are dynamically reconfigured. This responsive design maintains the visibility, legibility, and comprehensibility of the content presented on the display. At distance X 104, the display 105 shows a single large tile that takes up a large portion of the display area. At distance X/2 106, the display 105 shows three tiles that each take up a smaller portion of the display area. At distance X/4 107, the display 105 shows six tiles that are arranged in two rows. At distance X/8 108, the display 105 shows eight tiles arranged in two rows. As the end user approaches the display within the AR/VR environment, the responsive information display can be seen dynamically reconfiguring its contents in accordance with the design previously made and set by the user who designed the display.

As is explained in further detail herein, the proposed system and method allows the user to set a series of breakpoints at which the information display will transition between different features, contents, and/or layouts specified by the user, and these breakpoints are set in response to the apparent distance between the end user and the display within the AR/VR environment. In the illustrative examples in FIGS. 3-8 and 12-14, the user has set three breakpoints, at 5 meters, 10 meters, and 15 meters of apparent distance. In these illustrative examples the user has used the proposed system and method to establish four configurations of features, contents, and layouts, and the information display transitions between the configurations at the breakpoints set by the user.

The inventor contemplates other embodiments where the information display responds to inputs other than proximity and transition between different features, contents, and/or layouts. Non-limiting examples include where the information display responds to the end-user's gestures or verbal commands. For example, embodiments are contemplated where the information display responds to verbal comments. Thus, an end-user could say “Expand” or “Contract” and the information display may re-size accordingly. Alternatively, an end-user viewing a News tile could say “Next” and the next news story would be displayed on the tile. Persons of ordinary skill in the art will readily discern other inputs that may be used to cause the information displays to transition between different features, contents, and/or layouts. In addition, embodiments are contemplated where the information displays may respond to more than one type of input. For example, an embodiment may respond to proximity and to verbal commands by the end-user.

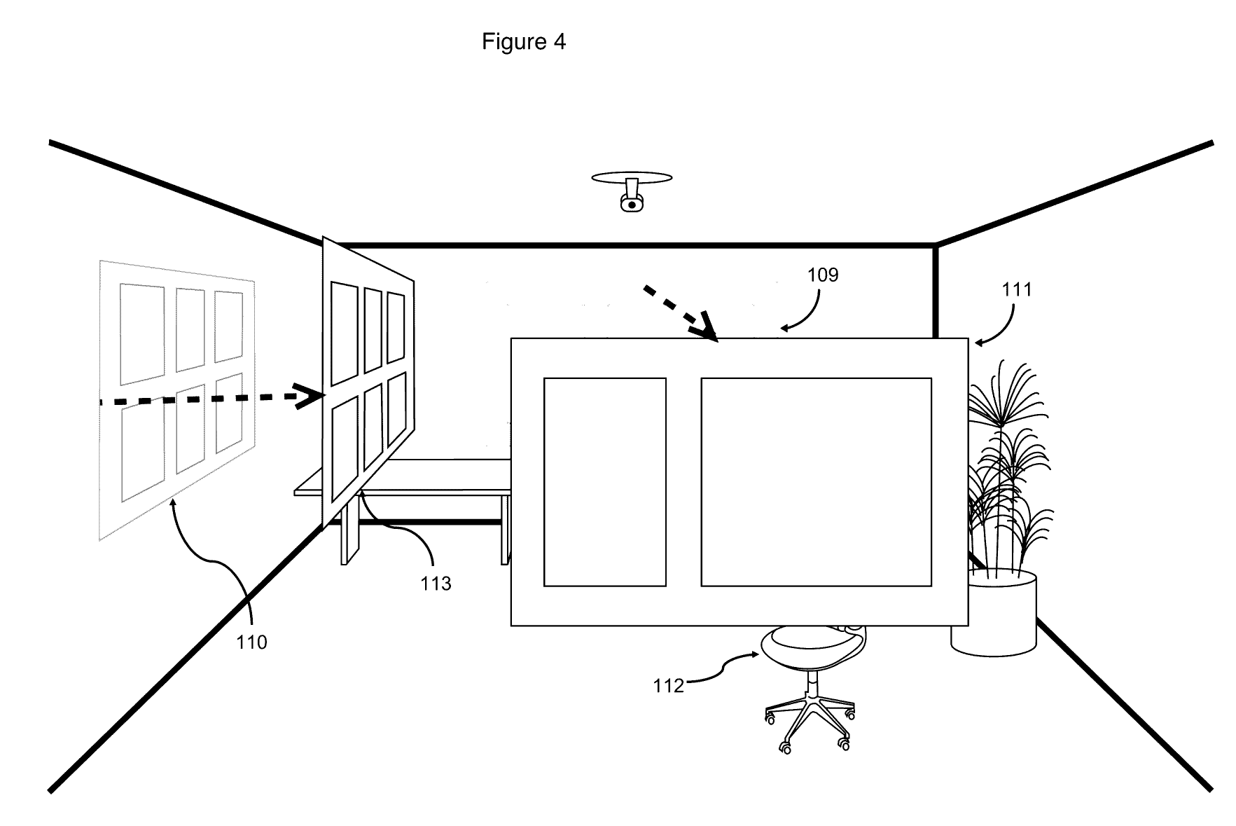

FIG. 4 shows an illustrative example of a user's ability to position or “pin” an information display in a certain orientation and in a certain place, i.e., setting its location at a particular position within the AR/VR environment. In the illustrative example of FIG. 4, the user has created two two-dimensional information displays 109 and 110 and positioned them flush with the walls, as a painting or flatscreen television set might be hung on the walls, in a three-dimensional AR/VR environment. The proposed method and system will allow the user in design view to set an absolute orientation and position for the information display. For example, in the illustrative example of FIG. 4, the user has decided to move the information display 109 closer to the user's position at a certain location in the AR/VR environment, and fix the display so that it appears and persists as an opaque, fully visible display in a new orientation and position 111 regardless of any change in the orientation or position of other physical or virtual objects, such as the chair 112, within the room. In the illustrative example of FIG. 4, the user has also opted to move the display 110 to a position further into the room 113. The proposed method and system will also allow the user in design view to set a relative orientation and position for the information display. For example, the user may wish to orient an information display horizontally and position it at an apparent distance of 0.5 meters above a specific object in the room, such as a table, and fix the display so that it appears and persists in that same orientation and position relative to the table, regardless if the orientation or position of the table within the room is changed.

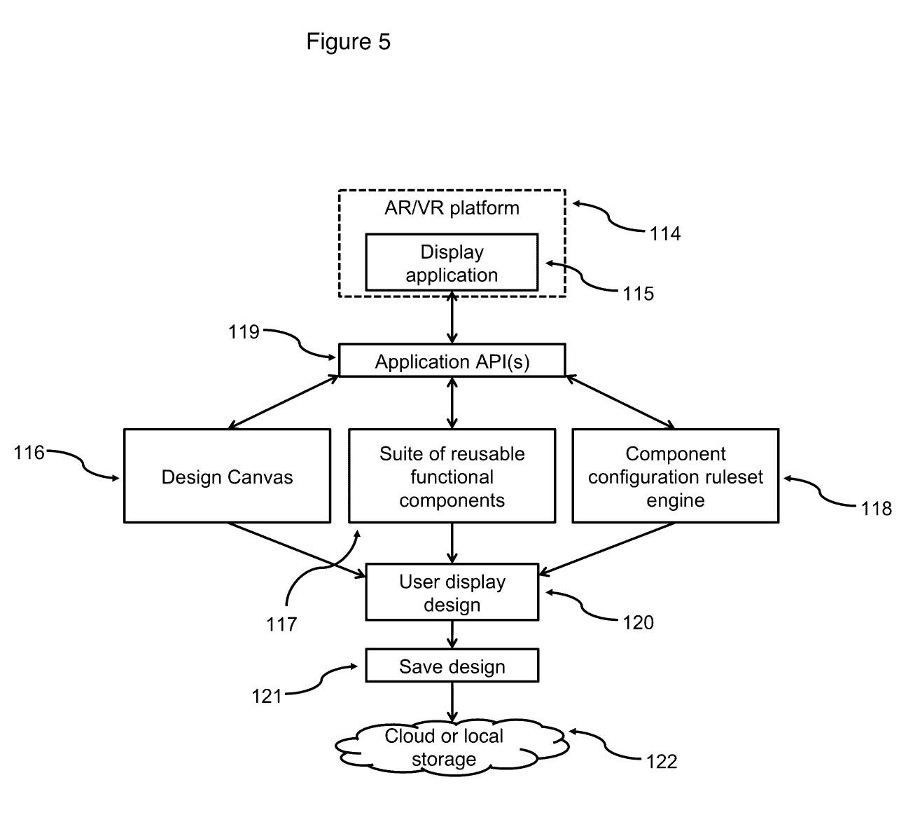

FIG. 5 illustrates an example system in which techniques for designing responsive information displays can be implemented, and the display designs saved to a storage system. The AR/VR platform 114 consists of AR/VR software and hardware: the AR/VR software generates the AR/VR environment that is viewed, controlled, and interacted with by users on AR/VR hardware. The AR/VR hardware can include displays, projectors, audio headphones or speakers, microphones, haptic feedback devices, and motion sensors or trackers. The display application 115 runs on the AR/VR platform 114, and presents information to the user and/or end user within the AR/VR environment, as well as receiving control inputs from the user and/or data from the AR/VR software. The design of the display consists of the design canvas 116 where the user has specified the placement of display components; reusable functional components 117 including containers, tiles, and applications; and a component configuration ruleset engine 118 consisting of connections to remote or local data sources, settings and rules for the responsive behavior of display components, and other information governing the dynamic response of the display to conditions in the AR/VR environment. All three elements of the display design send and receive function calls to and from the display application as defined by the application programming interface (API) 119 of the display application. Display design 120 consists of the user employing the display application UI to place display components on the design canvas and specify rules for their conditional response. The user can save the design 121 to local or remote “cloud” storage 122 for modification or use within the AR/VR environment.

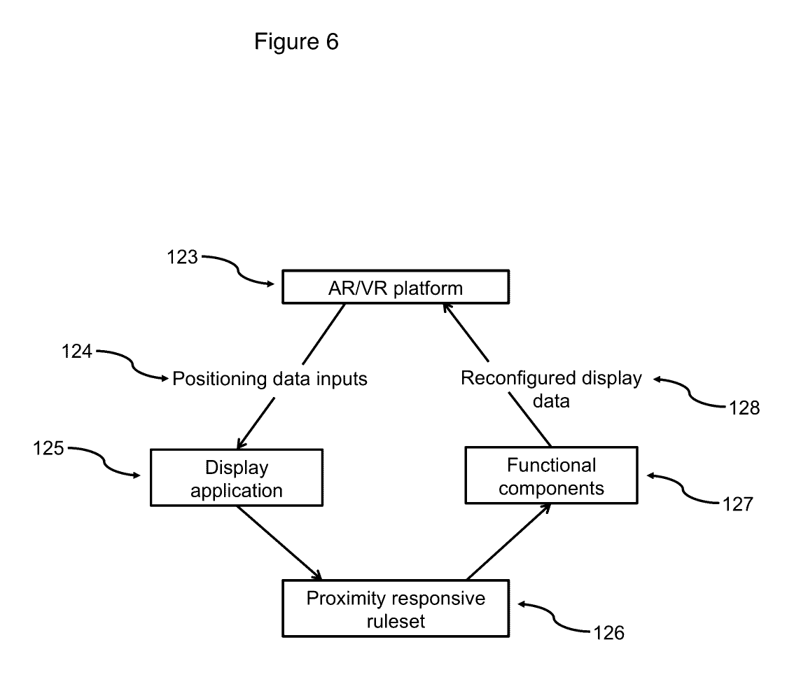

FIG. 6 illustrates an example system in which information displays respond to the apparent proximity of the end user to the display within an AR/VR environment. The AR/VR platform 123 sends data on the position of the end user 124 to the display application 125, which then triggers the component configuration ruleset 126 that was previously defined by the user during the display design process. The rules are applied to the functional components 127 of the display, which are dynamically adjusted in response to the position of the end user 128, and the resulting data is passed back to the AR/VR platform 123 for display in the AR/VR environment.

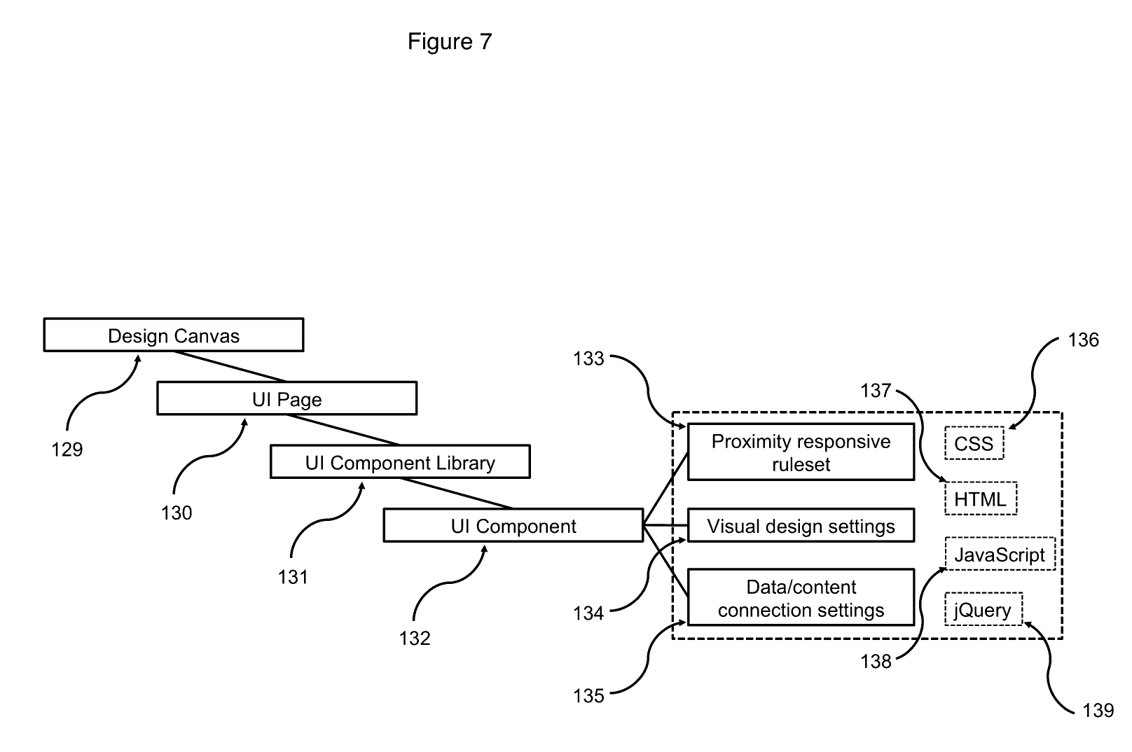

FIG. 7 illustrates an example hierarchy and makeup of items forming an information display as constructed on the design canvas. The design canvas itself, and the items within it, are based on widely-used and well-understood web technologies that are commonly used to format and display content in many software applications and user interfaces. These technologies use specific code to control the formatting, appearance, and responsiveness of static and dynamic elements in the display. However, by presenting the user with a simple control interface, the proposed system dynamically processes and implements the user's commands without requiring that the user directly manipulate such code. The proposed system instead presents the user with an interface of simple controls, and passes the control inputs into the code that makes up the items placed in the information display, to set their positioning and behavior.

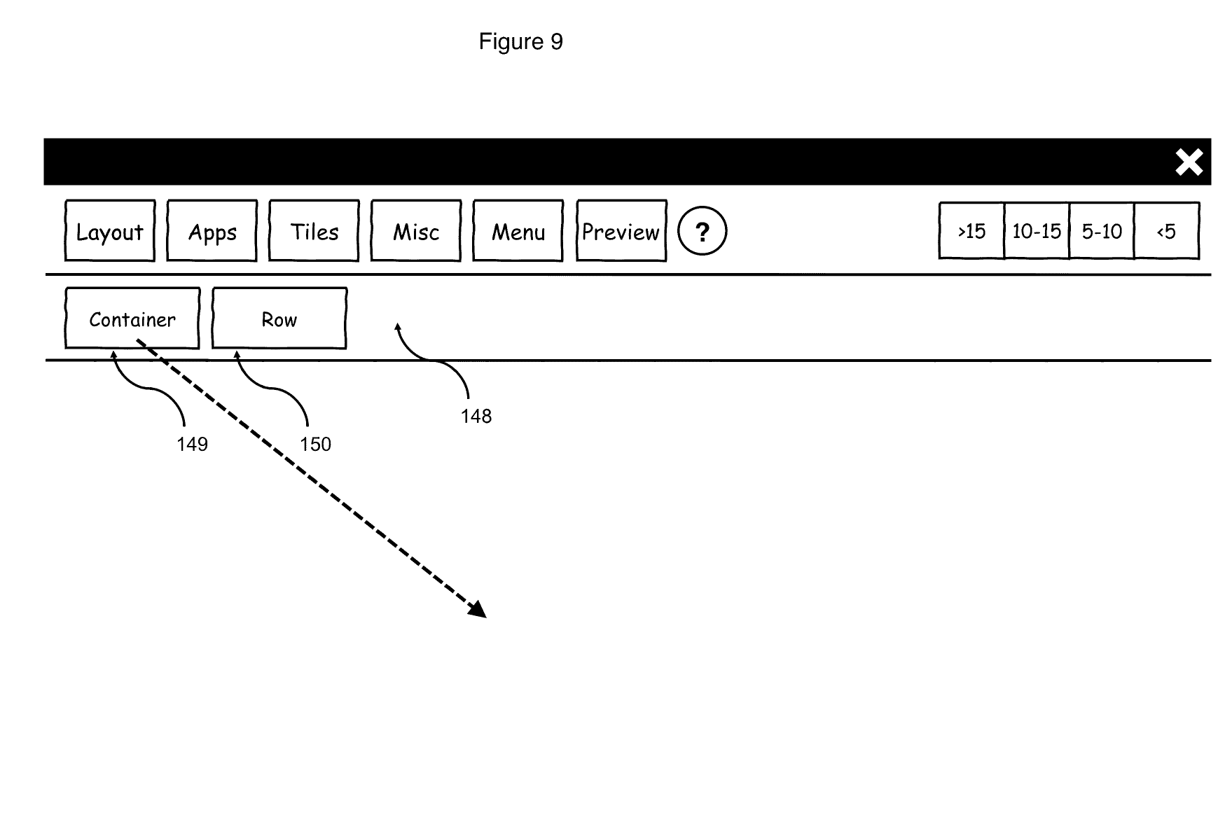

In the illustrative example of FIG. 7, the design canvas 129 presents a user interface page 130 to the user, and also offers a library of UI components 131 such as containers, rows, and tiles that may be set to display static or dynamic content linked to local or external data sources, as explained in greater detail in FIGS. 9-14 below. In the proposed system, a UI component 132 consists of elements including a proximity responsive ruleset 133, visual design settings 134, and data/content connection settings 135. Each of these elements of a UI component is made up of a collection of code, including but not limited to CSS 136, HTML 137, JavaScript 138, and jQuery 139. UI components have a default appearance and behavior in the information display, which are default configurations of the code that composes the proximity ruleset, design settings, and data/content connection settings.

In the illustrative example of FIG. 7, when the user is designing the display on the design canvas, the user will place UI components on to the canvas, adjust their position and size, and set their response to the apparent proximity of the end user to the finished display in the AR/VR environment, all by using a drag-and-drop interface and simple controls. Dropping a component onto the design canvas is the event that triggers the system to write or rewrite the CSS, HTML, Javascript, and jQuery code making up the UI components on the canvas. Because the system provides for showing or hiding content, changing the size and position of windows, and showing content with larger or smaller fonts or a lower or higher level of detail at various apparent distances from the end user, the system offers default settings for the behavior and appearance of windows, and allows the users to adjust these settings. Any movement, dropping, changing of position, or introduction of new components on the page triggers the system to pass new parameters into the existing CSS, HTML, Javascript, and jQuery code making up the UI components. This code is not set permanently at one time; the system can change the code at any time in response to user inputs, by passing new parameters into the code.

In the illustrative example of FIG. 7, the user may set a minimum width for a particular component, so that passages of text can appear at a legible size and without an excessive number of line breaks. When the user changes the width settings to increase the minimum width of the component, the system will change the design settings by passing new parameters into the CSS code that controls the dimensions of the component. When the user changes the proximity rules to show or hide the component at a particular apparent proximity of the end user to the display, the system will change the proximity ruleset by passing new parameters into the CSS and HTML code that controls the proximity-responsive behavior of the component. When the user changes the source of a calendar tile, for example so that that the calendar displays the user's vacation-planning calendar instead of the user's work calendar, the system will change the data/content connection settings by passing new parameters into the jQuery code that controls the information resource or API of the source.

The system can also include additional components that are not shown in FIGS. 5, 6, and 7. The example set forth above was an exemplary embodiment of the invention and is not meant to limit the scope of the invention.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

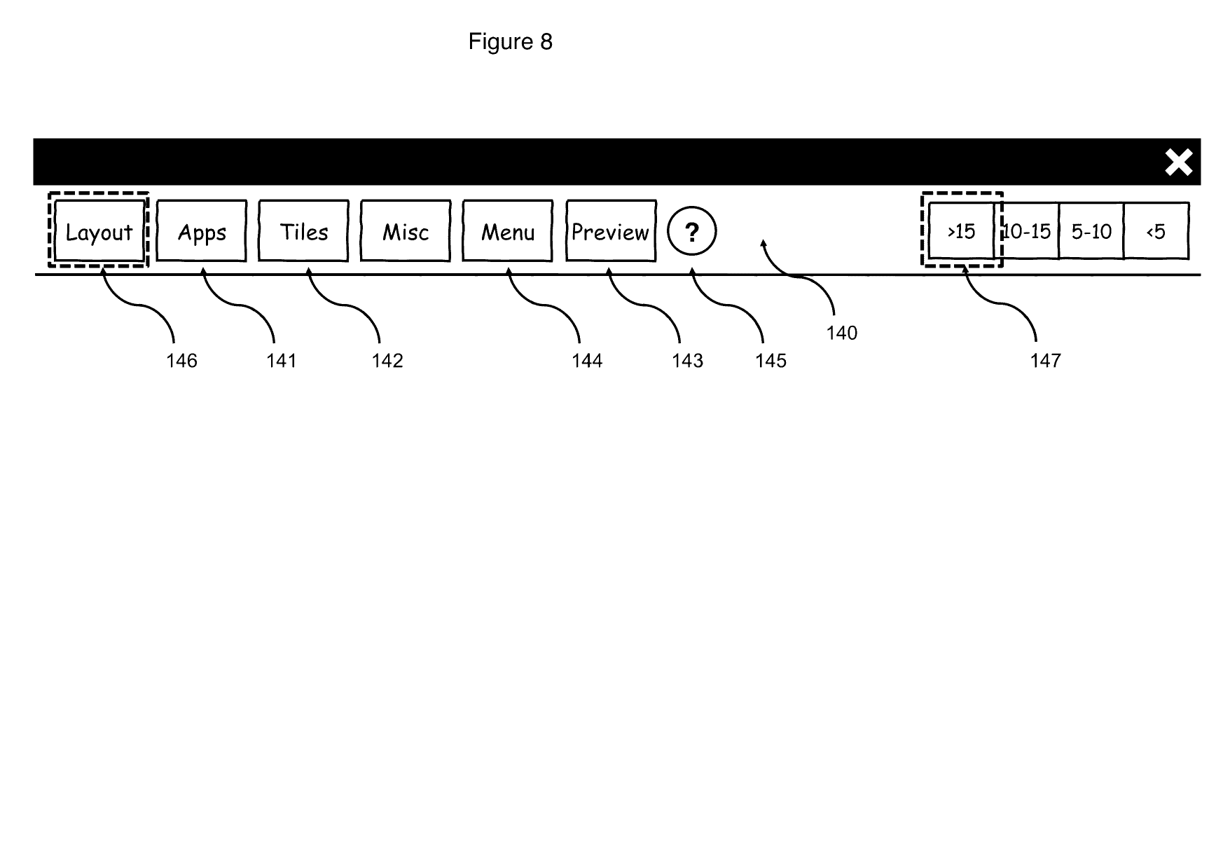

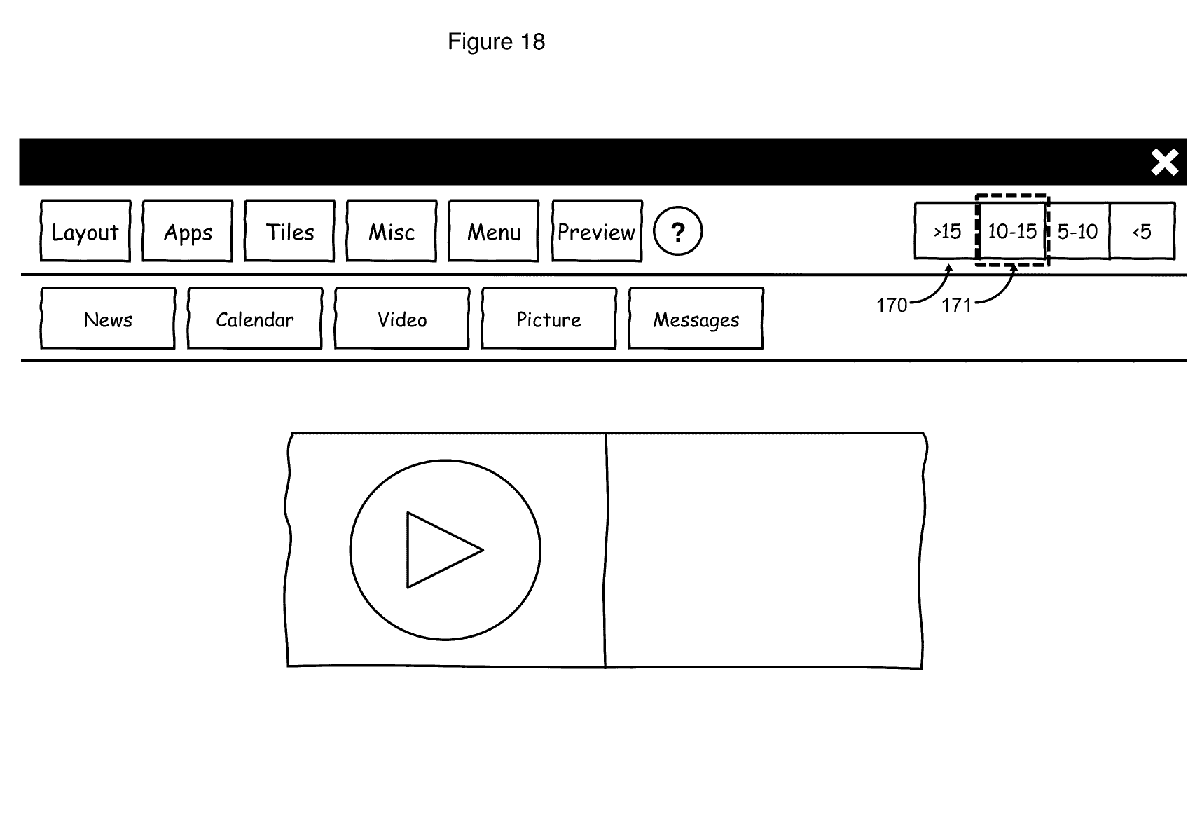

FIG. 8 shows an illustrative example of a user in the design view of the software design tool for creating and editing information displays. The proposed methods and systems will allow the user in design view, without knowledge of coding or programming, to set views and/or modes depending on the apparent proximity of the end user to the information display or other inputs. FIGS. 18-21 which will be discussed in more detail later herein show an illustrative example of a design view showing how the proposed responsive information display will appear at different apparent proximities to the viewer.

The system and method also may contain one or more views or modes depending on the situation or function required. For example, the system or method may contain a design view or administrative view that will allow a user to create and modify a responsive information display. Access to the administrative view may be limited to certain users to prevent unrequested modifications of a responsive information display.

All features, functions, or techniques can be set forth in one view or mode, or selected from drop down menus, or by selecting icons within the workspace, or by other techniques known to those of skill in the art. In a preferred embodiment, the system and method includes options to alternate the design view between the different configurations of features, contents, and layout proposed by the user, in order to preview and determine how the responsive information display will appear to an end user based on the apparent proximity of the end user to the information display within the AR/VR environment.

In the illustrative example, when a user wants to modify or create a responsive information display or a tile within the display, the user accesses a design canvas in a design view, which gives the user the privilege or the right to create and modify the responsive information display. For example, the user can access the design view by selecting the design view from a drop down menu, or by interacting with a toggle icon, or by another known method. In a preferred embodiment a user can either select a previously created template of an array of containers, rows and tiles or choose to create a blank display. Alternatively, the systems and methods can have one or more default templates that a user could select. These default templates may be the most used templates or the most preferred template for a particular apparent proximity to the information display. Previously created or modified templates can be saved by the user at any stage.

The proposed methods can provide default choices for each option that will be implemented if the user does not select a different choice. When the user is finished with the information display configuration options, the method can provide a technique for the user to accept the configuration parameters, whereupon these options are then implemented in the responsive information display. These can include, but are not limited to, a save option that is able to save changes to the information display, and/or an auto-save option to automatically save changes as they are made in real time. The design canvas may also contain one or more task bars containing various components. For example, the task bars may contain icons to assist in navigating between display views or within the design canvas itself.

The tiles described herein are managed in a tile design canvas within the software design tool. The tile design canvas can include any number of tiles. The tile design canvas can be a fixed, predetermined size. Alternatively, users can specify the size of the tile design canvas. In yet another alternative, the size of the tile design canvas can vary depending upon the number and location of tiles positioned within the tile design canvas or be based upon the interface of the AR/VR environment for which the information display is being designed. The tile design canvas can dynamically grow and shrink as tiles are added and deleted. There are numerous ways in which tiles can be added, modified or changed that are contemplated to be within the invention. In one embodiment of the technique there can be a box or area on the screen where tiles of pre-set size, shape, quality or function may reside. Alternatively, the user can create or edit tiles using pull-down menus, keystrokes, softkeys, icons and other known ways that would allow tiles to be created or edited into the design canvas.

Although the tile design canvas has been illustrated herein as a grid of rectangular tiles, neither the tile design canvas nor the tiles are limited to a rectangular form. In addition, while the method can provide a set of tiles of set size and shape the method is not limited to such sizes and shapes. Tiles can vary in size and shape. In addition, in the illustrative examples set forth herein the tiles have been depicted at evenly spaced intervals. However, the tile space can allow random or uneven distribution of tiles. Any arrangement of tiles that is useful to users can be utilized.

The illustrative example of FIG. 8 shows one possible design view of the method and system that would allow a user to create and modify a responsive information display for an AR/VR environment. In the illustrative example of FIG. 8 there is an icon bar 140 containing functions, represented by icons, that can be selected by a user. For example, the user may want to add apps 141, to add tiles 142, to preview the responsive information display as it would appear to the end user 143, to access an options menu 144, or access a help feature 145. In the illustrative example of FIG. 8 a user has selected the Layout function 146. In the illustrative example of FIG. 9 this has resulted in the display of a second icon bar 148 containing icons showing possible layout options. As stated above, the methods and systems of the invention contemplate other known methods and techniques by which a user can create and modify a responsive information display using, for example, drop down menus or softkeys. In the illustrative example of FIG. 9 the icon bar includes a configuration function allowing a user to add one or more containers 149 and a function 150 to add one or more horizontal rows.

In the illustrative example of FIG. 8 a Help button 145 is also added to assist the user. In the illustrative example, the Help button icon consists of a question mark inside a circle. In one embodiment, if the Help button is selected, a help dialog will appear as a module window in the design canvas. In other embodiments the help function may be accessed from different locations or in different ways.

In the illustrative example of FIG. 8, an icon bar 140 also includes options for adjusting the layout depending on the apparent proximity of the end user to the information display, which in this example are available for distances of “>15 meters”, “10-15 meters”, “5-10 meters”, and “<5 meters” between the end user and the responsive information display when in the AR/VR environment. In the illustrative example of FIG. 8, “>15 meters” distance has been selected 147, and therefore the design canvas shows the layout of the information display as would be viewed by an end user 15 or more meters from the information display in the AR/VR environment.

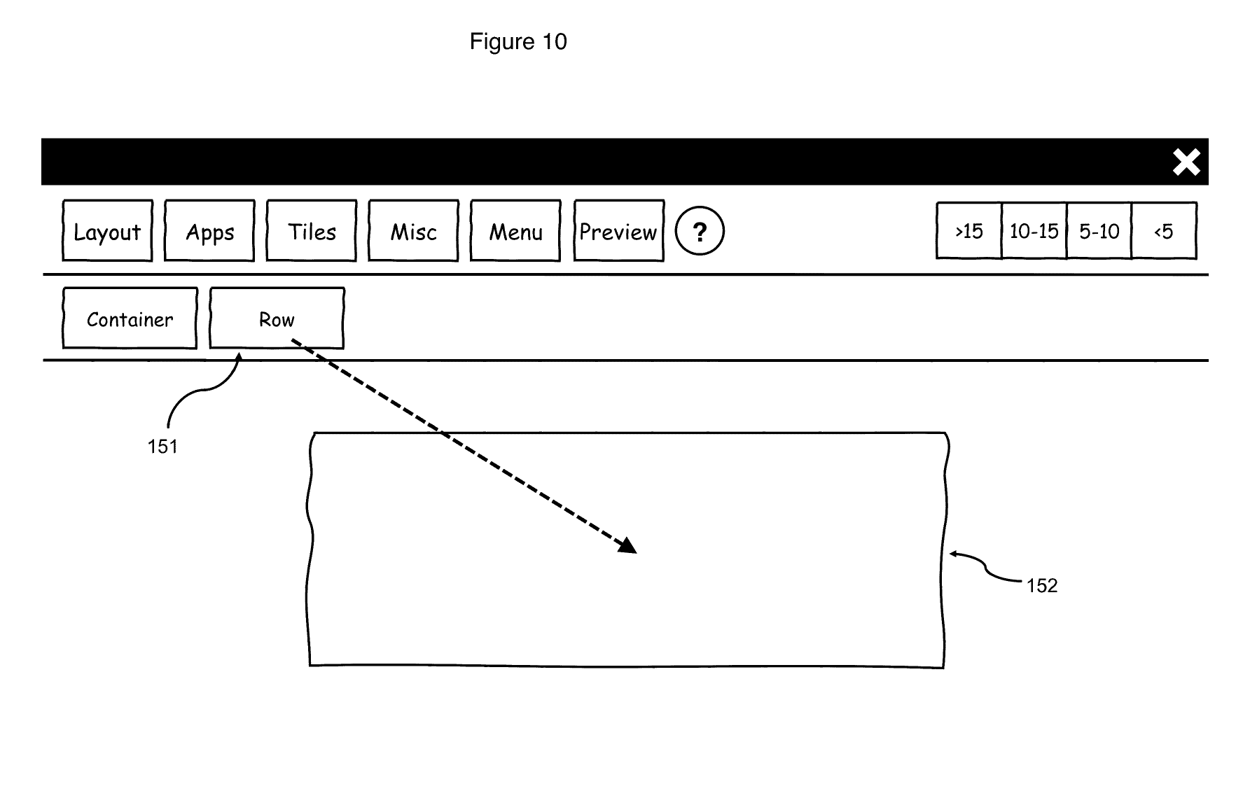

The illustrative example of FIG. 9 shows that a configuration function 151 has been invoked, in which the user has chosen to add a container to the information display. The container 152 is visible on the design canvas in the illustrative example of FIG. 10, which depicts the results of the activity in FIG. 9, i.e., dragging a container from the configuration space onto the design canvas. Other known methods are contemplated including using pull down menus or softkeys.

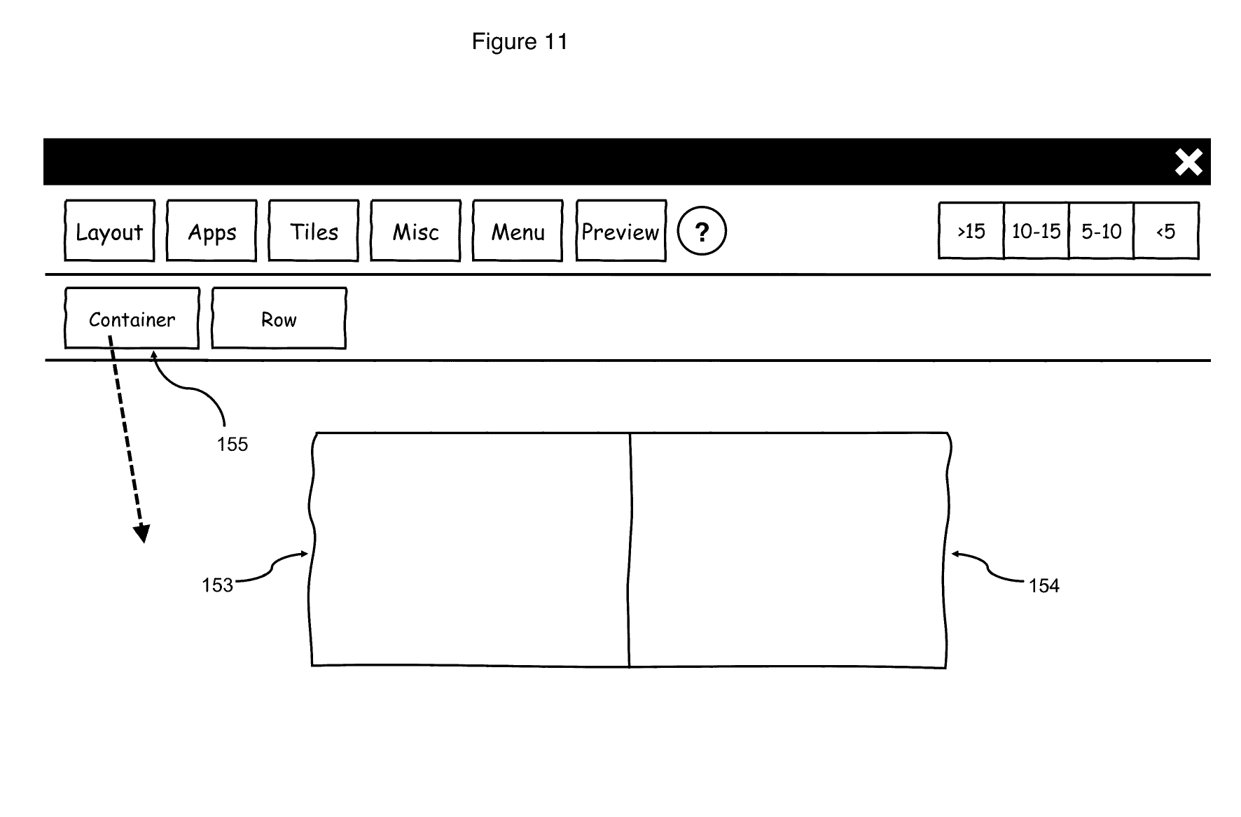

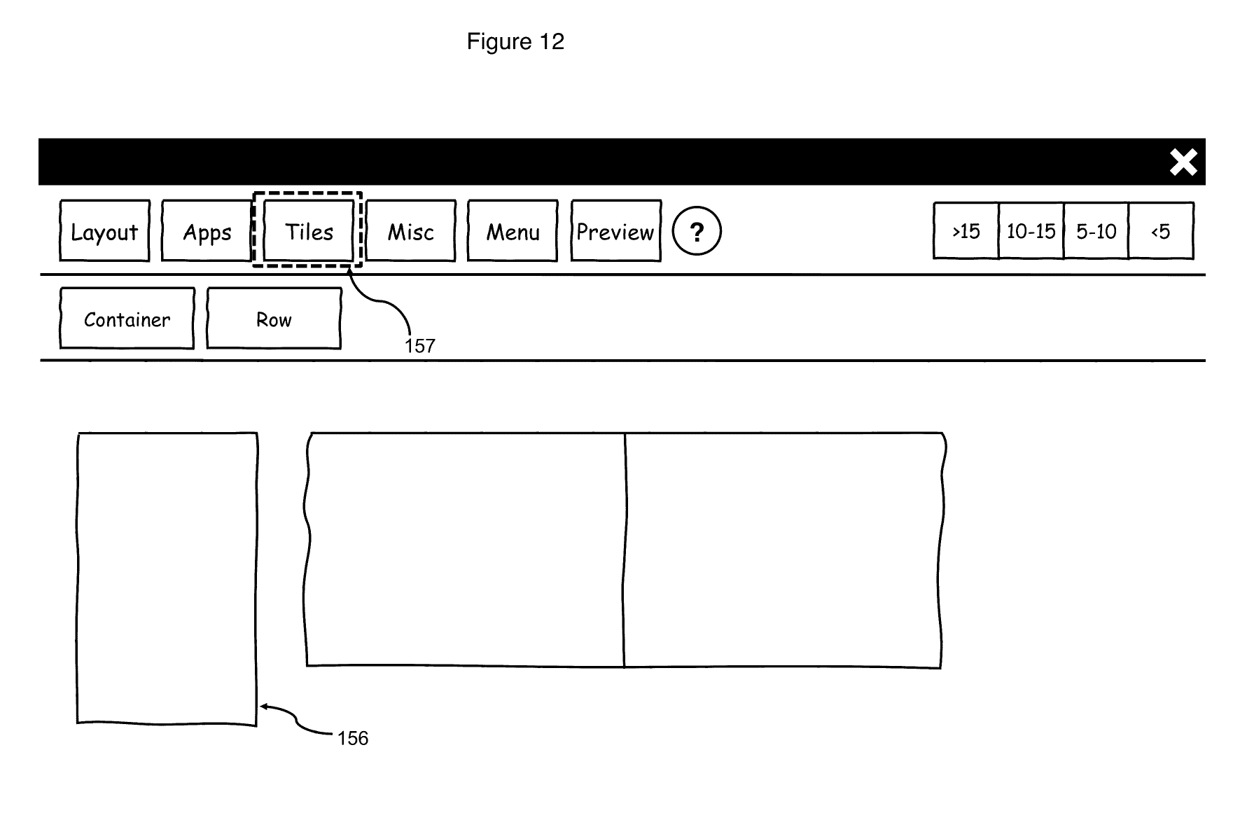

In the illustrative example of FIG. 10, the row function 151 has been accessed in order to drag a new row into the container already present on the design canvas. In the illustrative example of FIG. 11 the two rows 153 and 154 are now visible within the container on the design canvas. In the illustrative example of FIG. 11 the user has also accessed the container function 155 again, and is dragging a new container from the configuration space onto the design canvas. In the illustrative example of FIG. 12 the container 156 is then visible on the design canvas. These are only some of the features that the user can select. Additional features that user could select to create a responsive information display include the option to position the rows and containers as well as the ability to resize rows and containers. A person of ordinary skill in the art would understand additional options and features that could be used for the layout of responsive information displays.

In a preferred embodiment such as in the illustrative examples of FIGS. 8-11, in order for a user to be able to modify the rows and containers on the information display, the user will have to drag containers and rows onto the design area in order to add new areas in which the responsive design aspects of the information display will be used to structure the display. Other known methods to insert containers, rows or other layout features are understood as within the disclosed system and methods, including using drop down menus or softkeys.

In order to save the configuration that the user has designed, the user will have to save the information display. In the illustrative example set forth in FIG. 8, a menu of save functions is accessible through the “Menu” icon 144. In other embodiments the save function could be accessed by drop down menus or through softkeys. The save function may provide an option for the user to save the information display to either a gallery in which it can be used as a template, or as an information display that can be deployed to an AR/VR environment and/or subjected to further editing, customizations and/or revision. Optionally, the design canvas can be automatically saved either periodically or when the user exits the design view.

Preferably, after the user has configured the layout of the template or new information display, the user will then proceed to set up the content of the information display. For example, the user may first set up the containers and rows of the information display in the design view, using for example the Layout feature, and may then select the tiles and/or application tabs and/or other content that will appear in the containers and rows of the display. However, the order of the steps is not important, and the user has the option to perform any of the steps which are listed above and/or below in any order. For example, the user could first add tiles and applications to an information display, then add containers to change the look of the information display, and then drag the tiles into the containers in order to change the appearance of the information display.

Once the user has created the layout and content of the responsive information display, the user may have the ability to switch to different previews and/or design canvases that show how the created information display will look, based on the settings that the user has created for different apparent distances between the end user and the information display within the AR/VR environment. The user will have the ability to edit these changes within the preview, thus allowing them to select and modify tiles within the design canvas to edit.

It should be noted that the user can perform any of the multitude of functions of the software design tool described, such as selecting and moving tiles or groups of tiles in the current template, by using any type of input device or technique. One type of well-known devices is a computer mouse that contains a plurality of buttons, which allows a user to hover and select a tile and then drag it to the desired container and/or location, at which the user then opts to drop the tile in the location. Another input device considered by the inventor is a touch-sensitive screen that would allow the user to select, move and perform functions by touching the desired portion of the display interface. If the software design tool is accessed from within an AR/VR environment, the user may employ control gestures, verbal commands, or any other input technique that is used to control or interact with objects in the AR/VR environment.

The system and method of the invention can provide multiple templates containing a pre-determined mix of responsive container layouts or configurations, pre-determined content layouts or configurations, or a combination of both responsive container and content layouts and configurations. These templates can be selected or changed at any time through the software design tool, without the user having to directly adjust the code or programming. For example, a user could have set up a template configuration of similar content in which to deploy multiple information displays using this template. The user can select this template from among the pre-created templates that could have been created having the characteristics that the user has provided. If no template had been selected, the user will see a blank display as in FIG. 8.

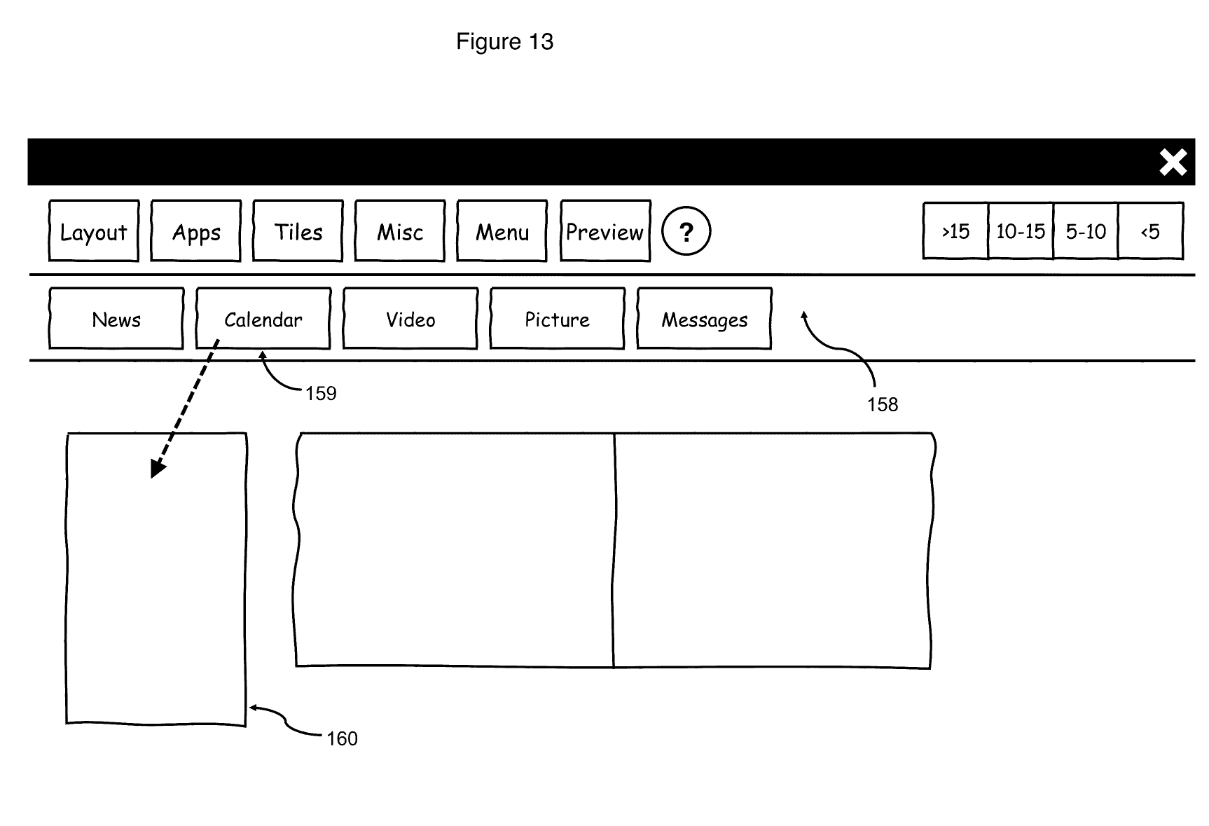

While the illustrative examples of FIGS. 8-11 show the arrangement of responsive containers on the design canvas, the illustrative example of FIG. 12 shows the user beginning to set up content within the responsive containers using a tile based system. In the illustrative example of FIG. 12, the user has accessed the “Tiles” feature 157. In the illustrative example of FIG. 13, this has caused a bar or folder of tiles 158 to appear in a second icon bar. The tiles that the user can access may be contained in one or more sources, including the a Tile menu folder, the user's own folder, a My Gallery folder containing tiles set up by an administrator, or a folder of grouped tiles. Other sources of tiles are contemplated by the system and method disclosed herein.

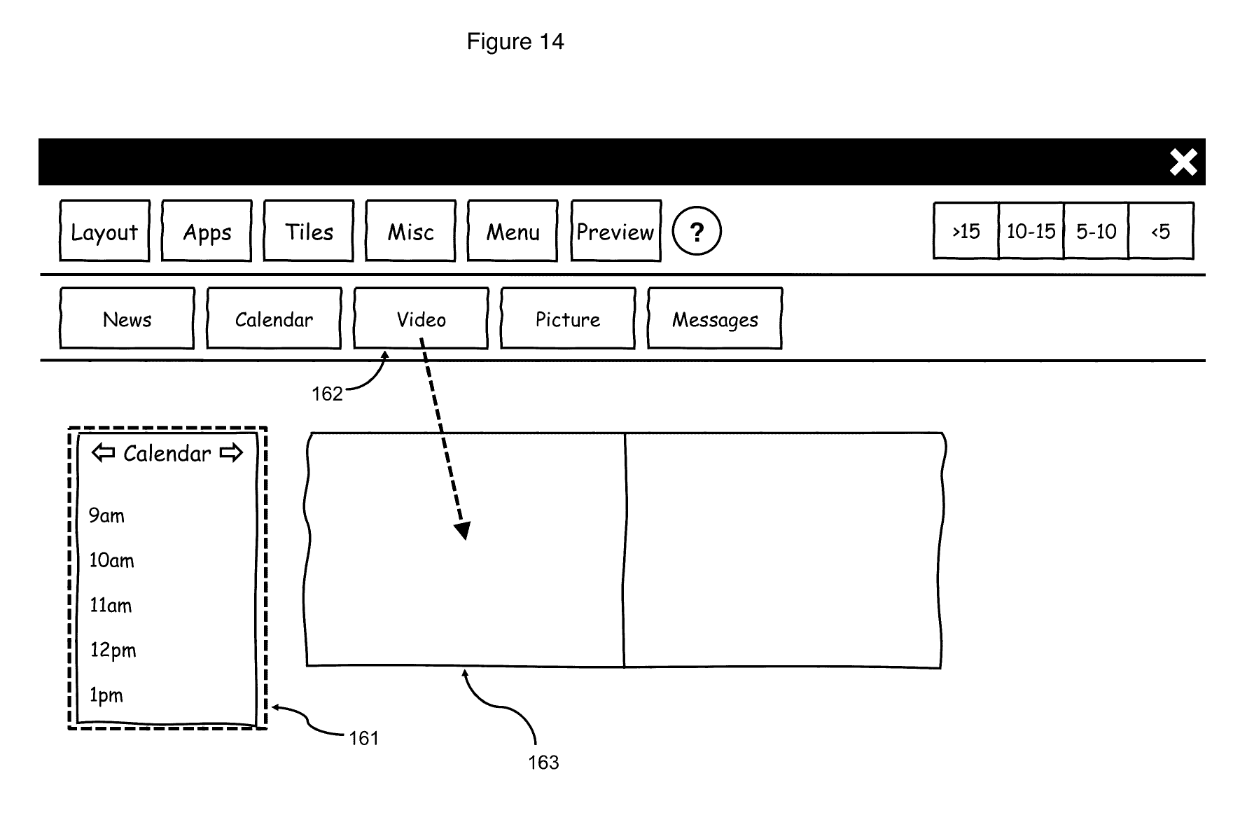

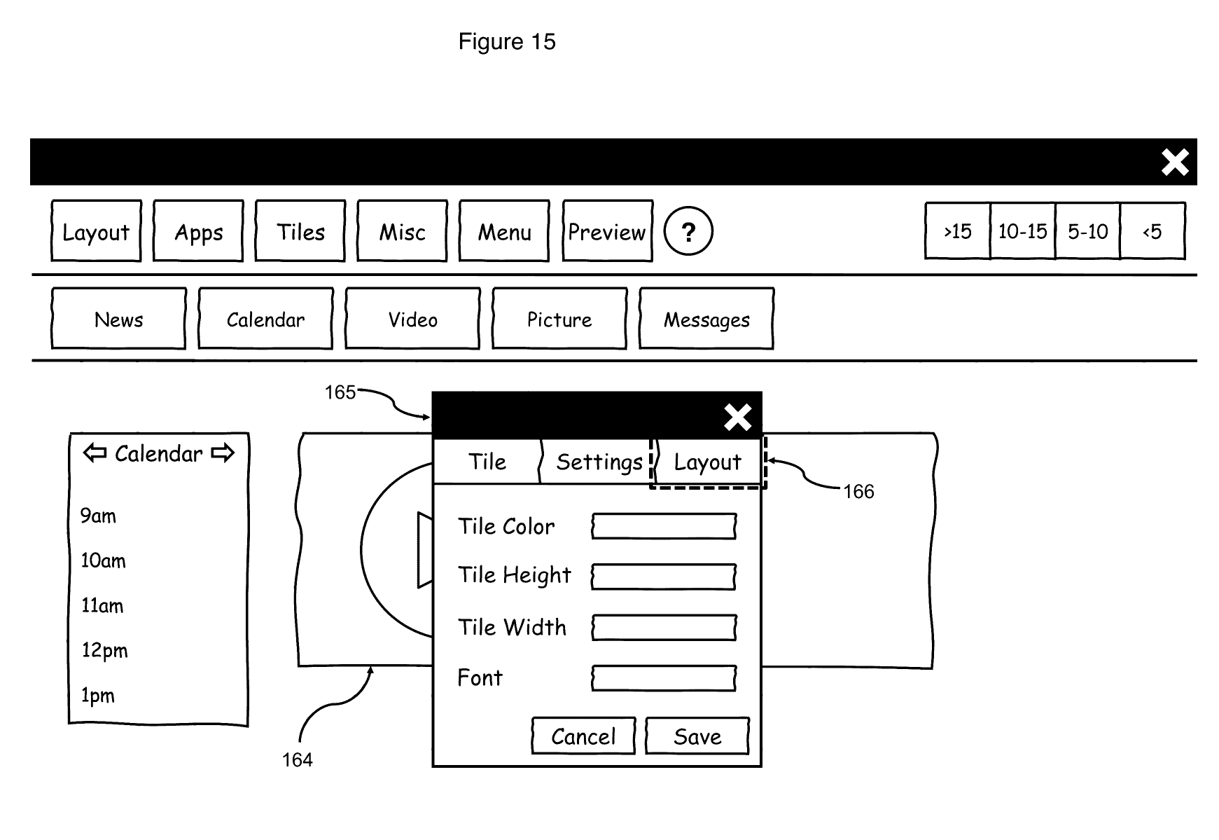

FIGS. 13 and 14 show illustrative examples of tiles that a user can place into the containers or rows on the design canvas. In the illustrative example of FIG. 13 a “Calendar” tile 159 was chosen from among the viewable tiles and placed onto the design canvas. In the illustrative example of FIG. 13 the user is accomplishing this by dragging and dropping the “Calendar” tile 159 from the icon bar into a container 160. In the illustrative example of FIG. 14, the “Calendar” tile is now visible within the container 161. The user can continue the process of dragging and dropping content elements into the design canvas. For example, in the illustrative example of FIG. 14, the user is choosing a “Video” tile 162 from among the viewable tiles, and dragging it to the right container 163 on the design canvas. In the illustrative example of FIG. 15, the “Video” tile is now visible within the container 164. In the illustrative examples of FIGS. 13 and 14 the content item is a tile, but the system and methods contemplates other contents and elements that would be available to be placed into the design canvas.

In addition, the content tiles or folders may contain subfolders or content organized in some fashion so that when selected the subfolder appears containing various related content tiles. For example, when the Video tile 162 is selected this may result in a subfolder appearing showing several different video tiles containing different content. The subfolders may contain further subfolders with additional content.

In a preferred embodiment of the system and method, the content placed into the design canvas, when placed into the design canvas, will expand to meet the area of the information display into which it is placed. The user will also have the option to resize the content within a container, allowing the user to place more than one item of content into a container without having to add extra containers to the display.

Embodiments of the system and method also allow the user to have the potential to resize the containers that are used to store the content that is being created by the user. These methods include the ability to enter the height or width of the tile as a number, or the ability to drag an edge or corner of the tile to change its size, in order to increase or decrease the dimensions of the tile in accordance with the preference of the user.

FIGS. 15-17 show illustrative examples of being able to show and hide content based on the apparent proximity of the end user to the information display within the AR/VR environment. In the illustrative examples of FIGS. 15-17 a user can access this feature by selecting a container, or the content within the container (i.e., a tile), which causes a menu of configuration options to appear.

The user would have the ability to then change the apparent proximities at which the container or the content would be visible. The user would also have the ability to include audio or video content that would become audible or begin playing when the end user is at a certain apparent proximity to a display within the AR/VR environment. In the illustrative example of FIG. 14, the user is selecting the “Calendar” content tile in container 161, so that a menu opens for the tile. The illustrative examples of FIGS. 15-17 show the user interacting with the menu 165 for the “Calendar” tile. In the illustrative example of FIG. 15, the user is selecting the Layout item from the menu by selecting the Layout icon 166.

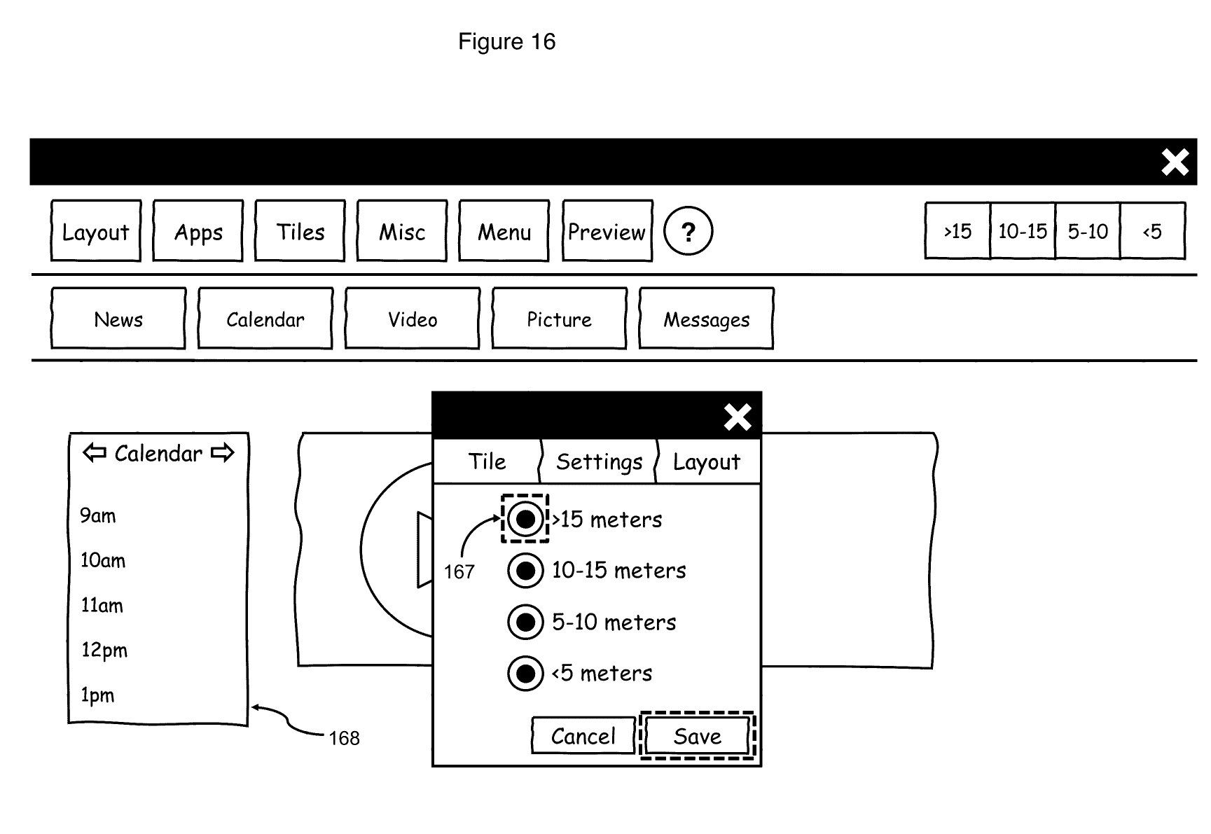

In the illustrative example of FIG. 16 the user has selected the Layout item and the menu now shows the layout options for the container or content. In the illustrative example of FIG. 16 four buttons, each with the option to select or deselect the button, have appeared. For example, in the illustrative example of FIG. 16 a button labeled “>15 meters” 167 is visible, indicating that the container or content will appear when viewed by the end user from an apparent distance of more than 15 meters from the information display within the AR/VR environment. This choice can also be adapted to other methods to indicate whether a piece of content or a container is visible or hidden, including icons that change color or shade when an option is enabled/disabled and/or a drop down box displaying text that outlines the available options.

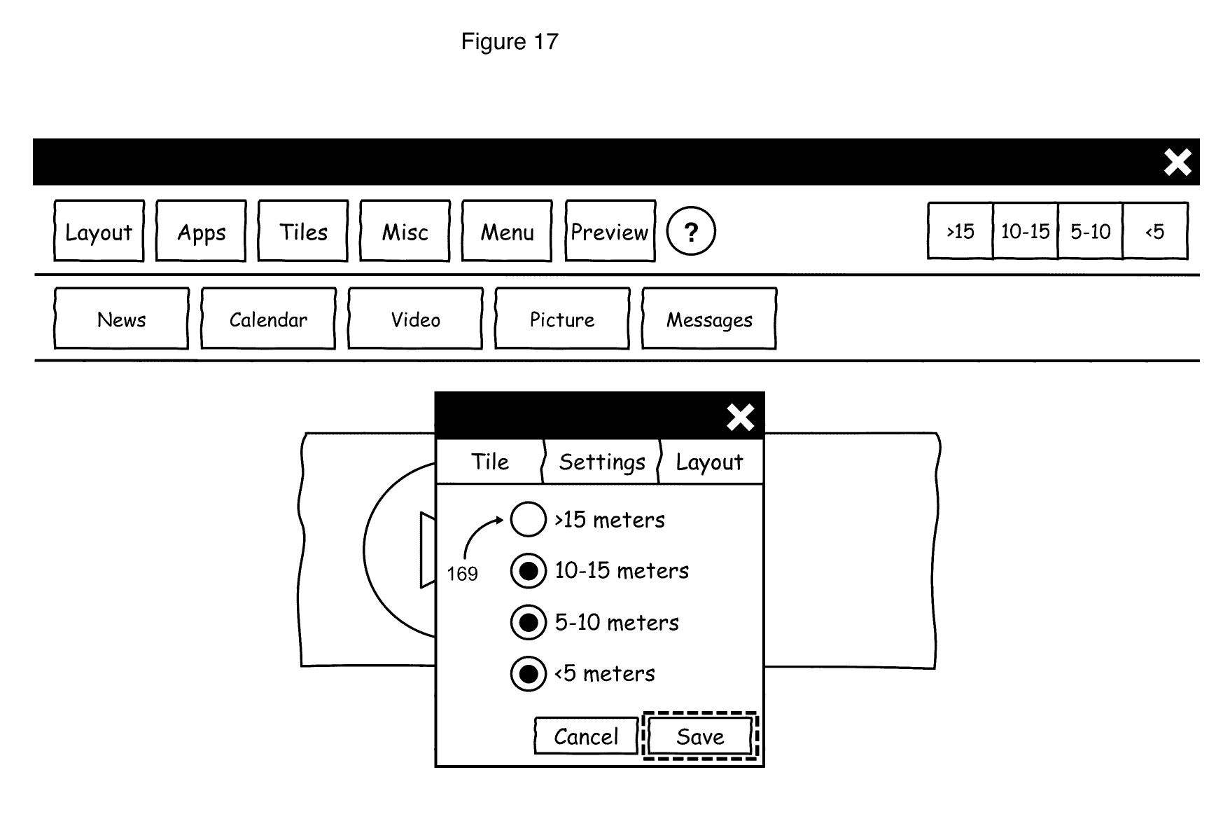

The user has the option to de-select content and/or containers for specified apparent distances at which the end user will be unable to see the de-selected content and/or containers. By de-selecting certain contents and/or containers the user is choosing to hide these contents and/or containers from end users at the specified apparent distance. In the illustrative examples of FIGS. 16 and 17, the design canvas is showing the configuration set by the user to be visible to end users at apparent distances of more than 15 meters from the information display in the AV/VR environment. In the illustrative example of FIG. 16, the “>15 meters” button 167 is selected for the Calendar tile, and thus the Calendar tile 168 is visible in the design canvas, which is currently in the “>15 meters” view. By comparison, in the illustrative example of FIG. 17, the “>15 meters” button 169 has been de-selected for the Calendar tile. The effect of de-selecting the “>15 meters” button is visible, and the Calendar tile no longer appears on the design canvas.

The system and method allows the user to choose what content is available at particular apparent proximities within the AR/VR environment. This has applications that can affect which content works within the confines of the proposed information display. One example of this is a newspaper article, which is likely to contain long passages of text and detailed photographs, and will thus be comfortable to read when the end user is apparently positioned close to the information display in the AR/VR environment. However, when the end user is positioned at greater apparent distances from the information display, a newspaper article would be difficult to read, or another functionality or application may offer a way of viewing the article that performs better at the greater apparent distance. In such a situation, the user is able to choose options on the design canvas that will hide more detailed content, or present a “lite” version of the content, when the end user is at a certain apparent distance from the information display within the AR/VR environment.

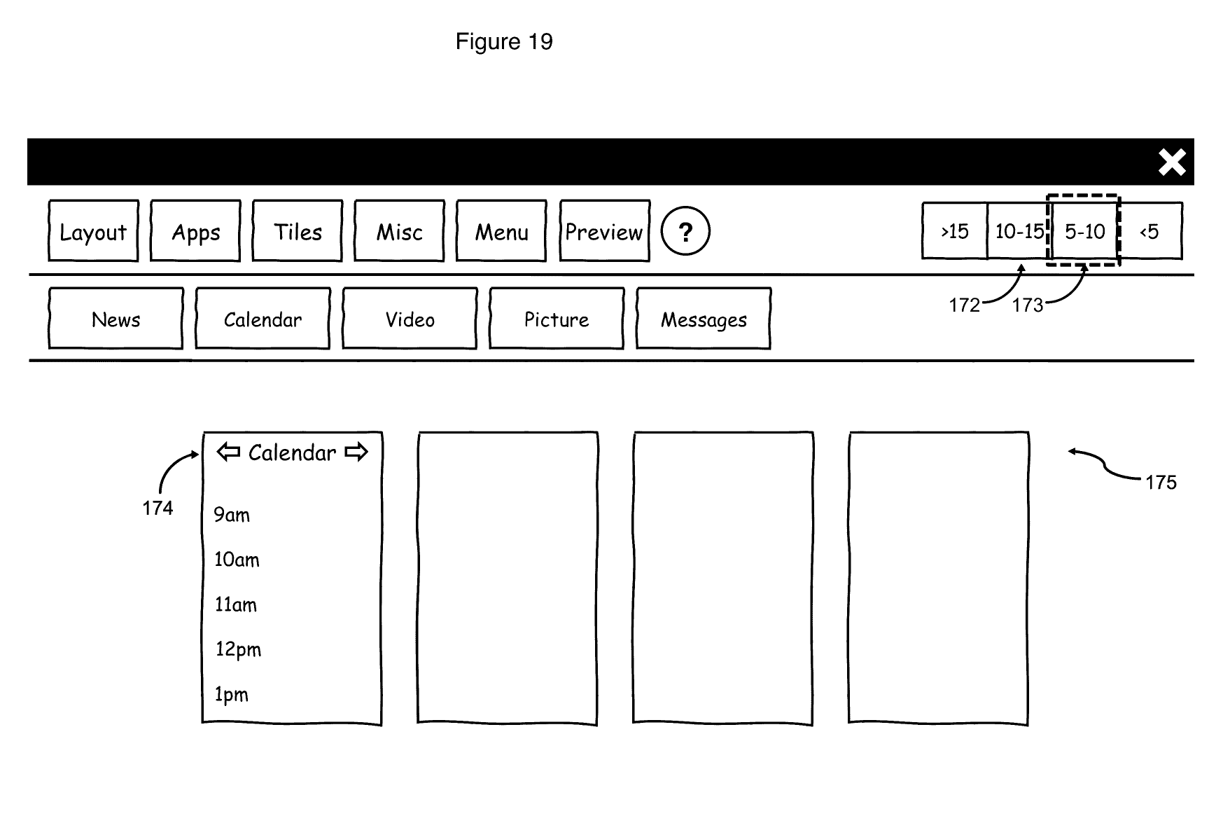

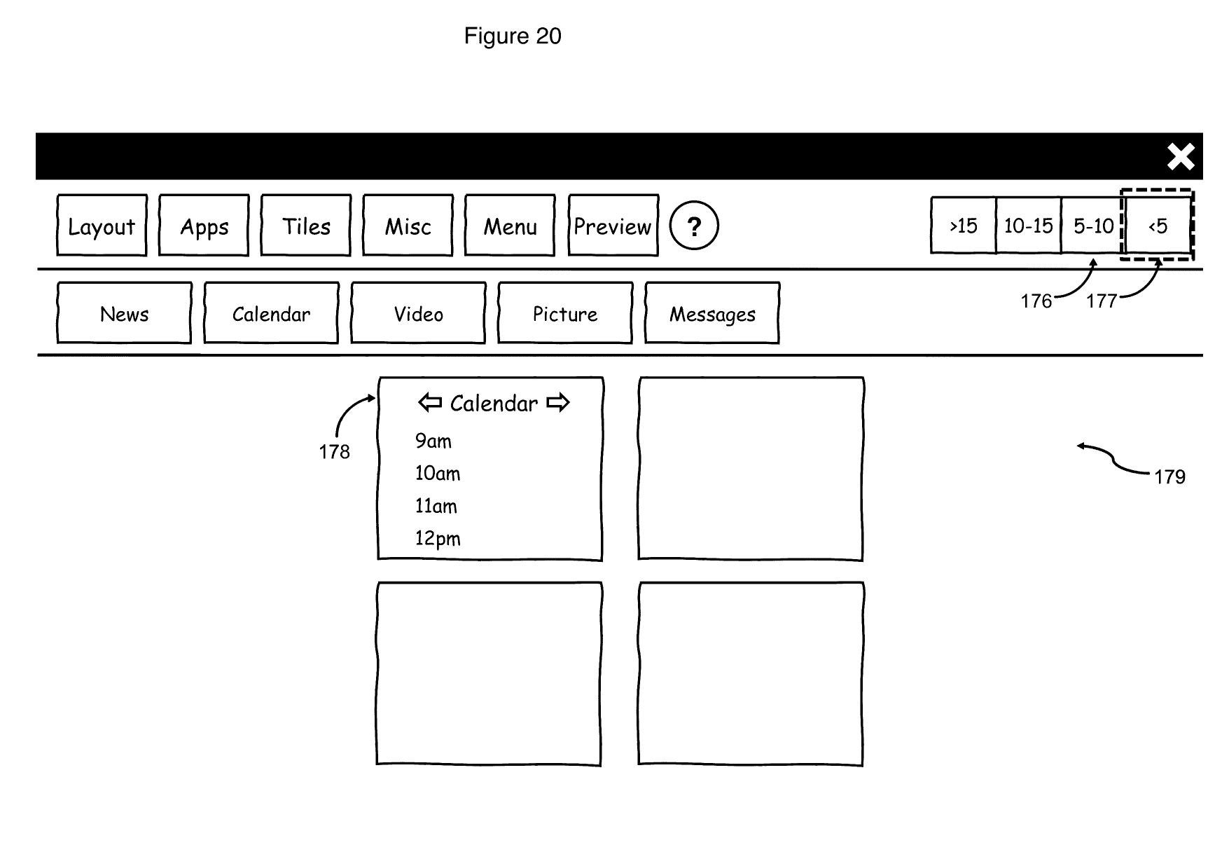

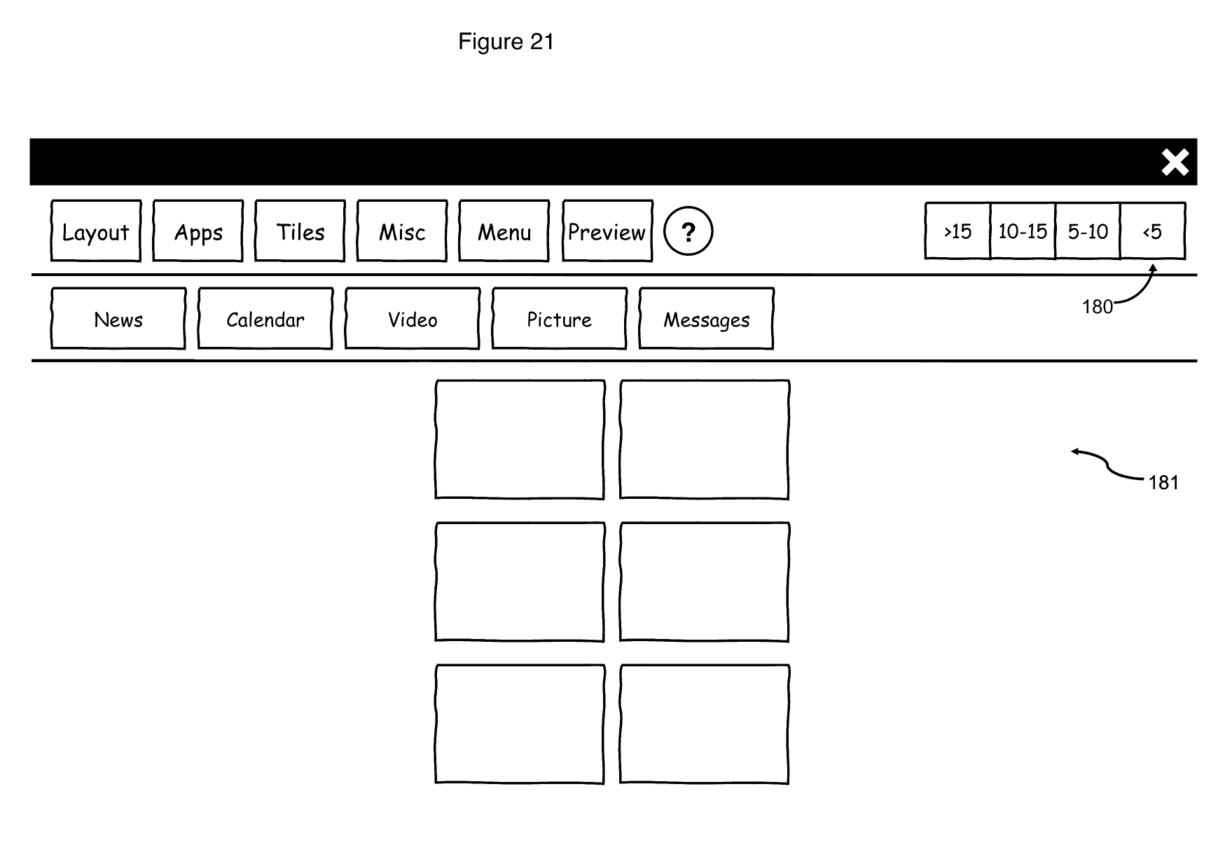

The illustrative examples of FIGS. 18-21 show the user selecting to resize the design canvas at different aspect ratios in response to an end user increasing or decreasing their apparent proximity to the information display within the AR/VR environment, and show the resulting change in the appearance of the design canvas. In the illustrative example of FIG. 18, the user is in the “>15 meters” view 170 of the design canvas, and is selecting the “10-15 meters” view 171. The illustrative example of FIG. 19 shows the result of selecting the “10-15 meters” view 172, and the design canvas has been resized and its aspect ratio changed in order to reflect the appearance of the information display as viewed by the end user at an apparent distance of 10-15 meters within the AR/VR environment. In the illustrative example of FIG. 19, the user is in the “10-15 meters” view 172 and is selecting the “5-10 meters” view 173. The illustrative example of FIG. 20 shows the result of selecting the “5-10 meters” view 176, and the design canvas has been resized and its aspect ratio changed in order to reflect the appearance of the information display as viewed by the end user at an apparent distance of 5-10 meters within the AR/VR environment. In the illustrative example of FIG. 20, the user is in the “5-10 meters” view 176 and is selecting the “<5 meters” view 177. The illustrative example of FIG. 21 shows the result of selecting the “<5 meters” view 180, and the design canvas has been resized and its aspect ratio changed in order to reflect the appearance of the information display as viewed by the end user at an apparent distance of less than 5 meters within the AR/VR environment.

In a preferred embodiment, the system and method cuts off the unutilized areas of the information display by hiding these areas with a colored border area such as 175 in FIG. 19, 179 in FIG. 20, and 181 in FIG. 21, into which the user is unable to drag any more containers, rows and/or content onto the design canvas. Also in a preferred embodiment, the system and method shifts the content within the design canvas, in order to reflect the change in the aspect ratio and size of the information display that occurs when the end user is at a particular apparent distance from the information display within the AR/VR environment. By allowing the user to set and adjust content and apparent proximity breakpoints, the system and method allows the user to dynamically set the features, contents and layouts of the information display that appear when the end user is positioned at different apparent proximities to the information display within the AR/VR environment. The user is thus given more choice in determining how the information display responds to apparent distances between the end user and the information display that are out of the scale or notice of pre-set design distances, and/or change the content based on the apparent proximities to better suit the intended audience.

As it stands the technical rules behind the breakpoints would function with the greatest apparent distances greater than or equal to the largest breakpoint, and the closest apparent distances being less than or equal to a particular breakpoint. For all other ranges of apparent distance between the end user and the information display within the AR/VR environment, the system and method allows a user to set maximum and minimum breakpoints to show when the information display will change from one state to another state. The software design tool permits the user to easily change these settings without requiring extensive skill or technical expertise.

This method also allows for responsive design when in the design view. As shown in the illustrative example of FIGS. 19-21, the application changes the appearance of the information display in order to accommodate the apparent distance from which the end user would be viewing the information display when in the AR/VR environment. In the example of the design view illustrated in FIG. 20, when in the “5-10 meters” view 176, the information display re-arranges itself, and the container displaying the “Calendar” tile shifts from the far left side 174 as seen in FIG. 19, to the upper left hand position 178 as seen in FIG. 20, as previously determined and selected by the user.

The described system and method allows the user to pre-select the maximum number of columns and rows that are visible at a particular apparent proximity, in order to allow the information display to become more responsive, without forcing the user to hard code what rows are to be moved and where, or create multiple rules and/or information display files to accommodate changes in apparent distance between the end user and the information display when in the AR/VR environment, and to be able to rearrange the features, layouts, and contents in order to accommodate various apparent distances. As shown in the illustrative example of FIG. 21, the user has determined that the information display show two columns and three rows when the end user is at the least apparent distance from the display.

This method also allows for the potential for users to select the order in which content and containers are rendered in the information display. This allows a user to minimize the amount of time that is needed to load the display, by not having to hide certain content that the user may choose to place in a different area of the information display. An example of this would be a search bar that the user may generally prefer to place at the top right of the information display. However, at greater apparent distances between the end user and the information display, the user may wish to place the search bar at the bottom of the information display. By nominating the container where the search bar is located, and using drag and drop to place the container in the top right of the display for some apparent proximities and at the bottom of the display for other apparent proximities, the user will not have to place two search bars on a single display.

The user also has an option to choose to see how the proposed responsive display will look from the perspective of an end user. In the illustrative example in FIG. 8, this “Preview” option 143 is located in the icon bar, and gives the user the ability to preview the information display as it will appear to an end user, without the menus, toolbars or other interface elements of the software design tool. As such, this will allow the user to see how this content will appear at various apparent distances, i.e., to review the positioning of the content that the user has created, and/or to review how the information display will look through certain changes and/or testing.

This method overall allows the user to quickly and easily create responsive information displays for AR/VR environments with a software design tool, without requiring that the user have knowledge of computer code and/or specialized education in order to create the information display.

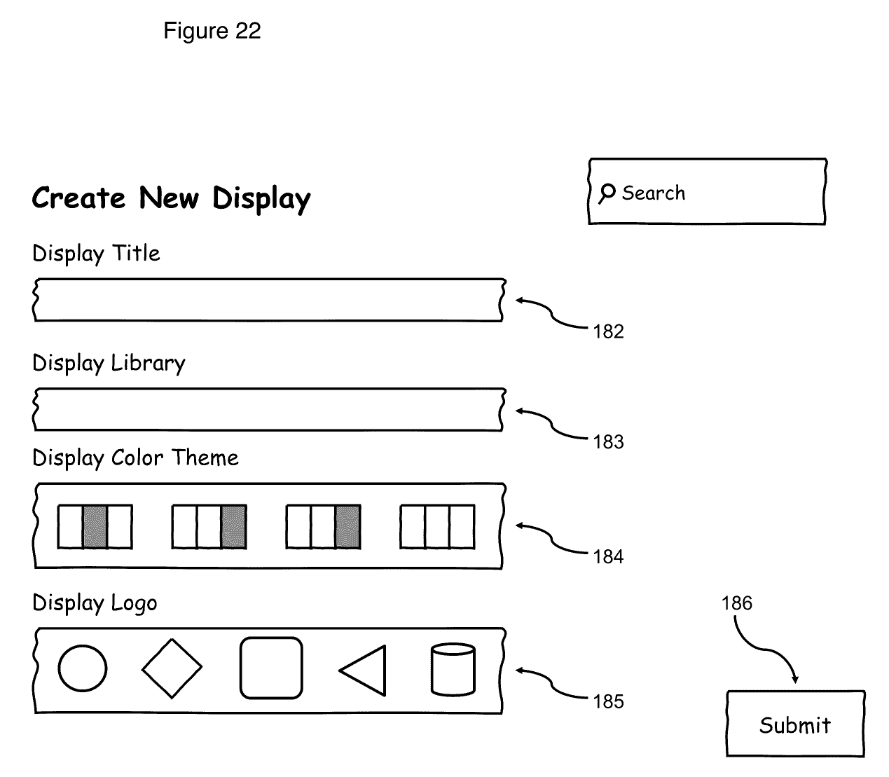

FIG. 22 illustrates a user in administrative view creating a new information display. In this example, the user is prompted to give the information display a title 182, add it to an information display library 183, pick a color theme 184, and select a display logo 185. These are only some of the features that can be selected. Additional features can include background, application link, list of application types, and preview in the application gallery. In the illustrative example of FIG. 22 a Submit button or icon 186 is provided for the user to accept the configuration options selected. Selecting this will implement the configuration options and take the user out of the configuration function.

Preferably, after the user has configured the selected template or new information display, the method will proceed to the design canvas where the user can add to, delete from, and modify elements of the information display. However, the order of the steps is not important and any of the steps listed above and below can be performed in any order. For example, configuration of the information display can be done after the tiles have been added, moved or deleted from the design canvas. In addition, the method allows the user to edit the information display at any time or during any of the steps.

The method can provide a plurality of templates containing pre-determined tile layouts or configurations. The templates can be selected or changed at any time. For example, the user could have selected a particular template at the information display creation step or, if the user elected to create a new information display, then at the design canvas step. The user can select among these templates for the template having the characteristics desired by the user. In an embodiment of the method, if no template is selected by the user, the user will see a blank design canvas with gridlines.

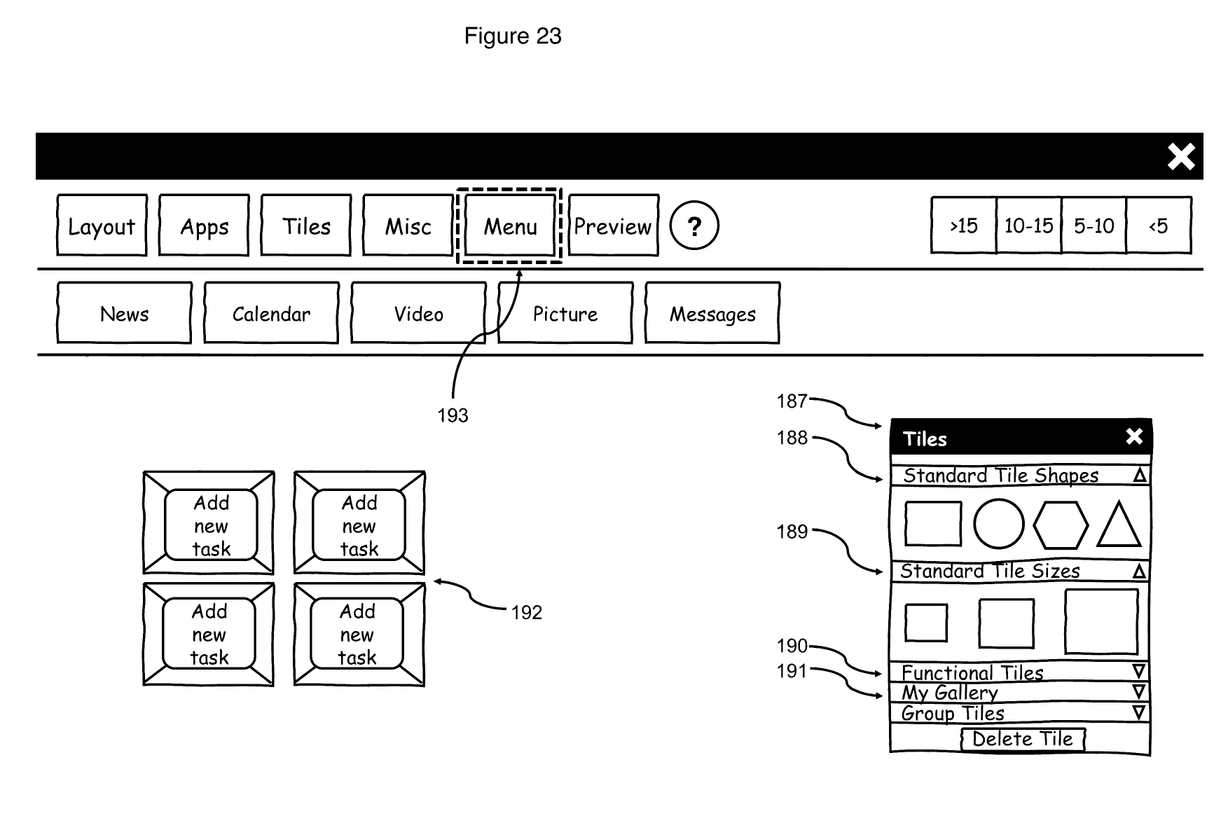

In the illustrative example of FIG. 23, a Tiles menu box 187 is present, from which the user can select one or more tiles and tile characteristics. Alternatively, the user can be presented with a blank design canvas and through user action or by prompts select a template. It should be noted that the order for creation and placement of the tile into the design canvas is not important. For instance the features of the tiles can be set first in the Tiles menu box, and then the tile placed into the design canvas. Alternatively, tiles can be placed before to their content and features are inputted. Likewise, the tile configuration can be done prior to adding a title, theme or other attribute such as those set forth in the illustrative example of FIG. 22. This is true of all of the steps of the method. Steps can be carried out in any order that results in the creation of an information display for an AR/VR environment.

In the illustrative example of FIG. 23, the Tiles menu box 187 has its “Standard Tile Shapes” 188 and “Standard Tile Sizes” 189 folders selected. In an embodiment of this method when the user selects a folder contained in a box or list, the selection expands to provide more information related to that selection. In the illustrative example of FIG. 23, when these folders or links were selected, these selections expanded to reveal the set of standard tile shapes and standard tile sizes available for the user to select. The method can provide that when selected, any folder, tab, or component will expand to reveal the contents of that folder or tab or reveal more information or data. However, other techniques for accessing functions or folders in contemplated as within the invention.

In the illustrative example of FIG. 23, the Tile menu 187 also contains a folder, component or tab containing “Functional Tiles” 190 which allows the user to select one or more functional tiles to place into the design canvas. Additional folders, component or tabs may be provided from which tiles may be selected. For example, a folder, components or tabs may contain the universe of tiles and templates that have been created in the past by the user or an organization. Another folder, component or tab may contain a list of tiles and templates that the company or administrators have created. Further, a list of Group tiles showing the universe previously created tile groups can be provided as well as any list of available or previously created tiles.

In the illustrative example of FIG. 23, the My Gallery folder, component or tab 191, which in this example is contained in the Tile Menu, contains a list of tiles that a company, organization or administrator has created. When a user selects the “My Gallery” tab 191 on the Tile Menu, it will display a list of tiles that the company or administrators have created. A search method to search for tiles, templates or groups of tiles within the My Gallery tab or other tabs, menus or folders can be provided.

The Tile Menu box or similar area can contain other folders or menus containing tiles or group of tiles that can be added to the design canvas to allow customization according to the preference of the user.

In the embodiment illustrated in FIG. 23, the user will be able to drag and drop as many tiles from the Tile Menu that can fit on the screen or that the user wishes to place on the information display. On the drop of the tile, the method provides a technique that will properly place the tile to fit within one of the gridlines so that tiles can be easily aligned without the need to move each tile pixel by pixel. In FIG. 23 tiles 192 have been dropped and properly placed within the design canvas.

Other techniques for selecting tiles to be placed in the design canvas and to indicate the position at which the user desires such selected tile to be placed are within the method of the invention.

The method can provide techniques for automatically placing, sizing or reflowing the array of tiles into which, or from which, a tile is placed or moved. As part of reflowing tiles within an array, various rules may be used, such as top-to-bottom and then left-to-right. Other rules may instead be used, such as right-to-left or bottom-to-top (e.g., in cultures where language is not commonly arranged left-to-right).

The method can provide techniques for fitting the tiles onto the design canvas. This can occur for example, if the user attempts to fit a tile of a set size onto a portion of the design canvas that does not contain enough space for the selected tile. In one embodiment the method will visually or verbally inform the user that the selected tile cannot fit in the desired space. The method can provide techniques for re-sizing the selected tile or one or more of the tiles currently in the design canvas to allow the selected tile to fit within the desired area on the design canvas. The method can also provide techniques for resizing the design canvas.

Further, prior to placing the tile at the selected location, the technique can indicate the location at which the selected tile will be placed, such as through tilting an immediately superior tile or a current tile in the location responsive to a dwell, hover, or movement over the location of the selected tile. The technique may also indicate the location by previewing the arrangement of the array should the tile be placed at the location and the array of tiles be reflowed based on the placement.

The method can also provide techniques that allow a user to extend the tile design canvas. These techniques may be provided in the administrative menu, in a separate view or accessed in any of the views by user action. Likewise, these techniques may be accessed in any numerous ways known to the person of skill in the art.

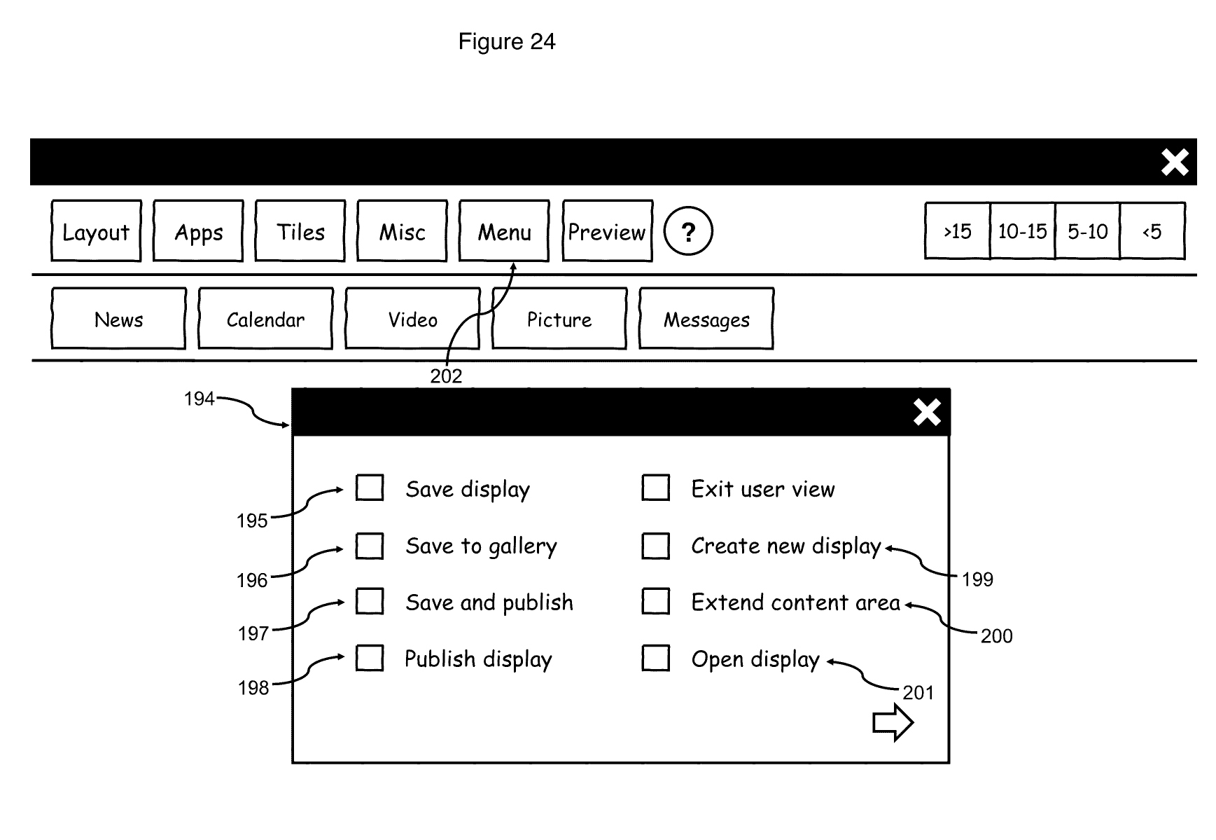

In the illustrative example of FIG. 23, the user is selecting the Menu icon 193. In the illustrative example of FIG. 24 the Menu box 194 is now open, and the user can select the “Extend Content Area” feature 200 to extend the design canvas. The edit menu may also contain other techniques to provide a host of other functions and tasks.

When an extension is selected that will result in the design canvas being larger than the display interface, the method can provide techniques to allow the user to navigate such as by providing a scroll bar. In an edit mode this will allow the user to add tiles to the design canvas in areas previously not displayed. When the information display is in normal view mode or end user view the technique can provide a scroll bar to allow the end user to scroll through the whole design canvas.

The method can also provide the users the ability to delete tiles. There are numerous techniques known to those skilled in the art that can achieve this function. For instance the tiles themselves can contain a functional or softkey bar that contains functional components such as a delete function. This bar may be always visible, may appear only when the tile is selected, or may appear when a selecting device hovers over the tile. Alternatively, functions, including a delete function for a tile, may be accessed by specially selecting the tile, or may be accessed in the taskbars of the application. Other techniques can be employed in the method to perform functions, including deletion of tiles or groups of tiles.

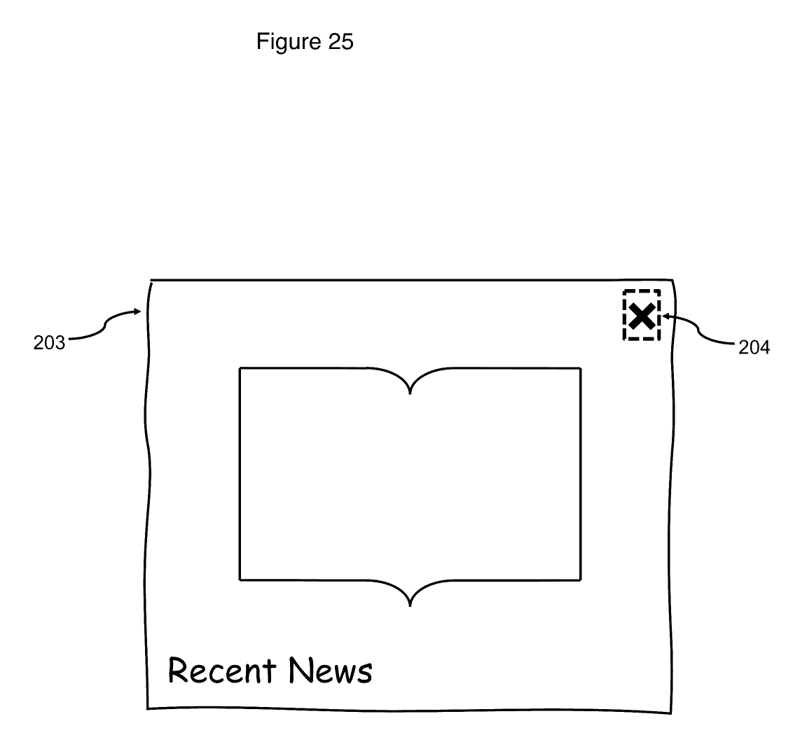

In the illustrative example of FIG. 25, the tile itself 203 contains an “X” 204 at the top of the tile. Selecting the “X” will delete this particular tile. Preferably, when the “X” is selected, it will prompt the user with “Are you sure you want to delete this tile? Continue/Cancel.”

As stated above the method can also provide other techniques that perform other functions. These can include create new information display, save changes, save to a list or gallery, go to another view, save and publish information display, publish information display, end the current view and a host of other possible functions. As stated above, these functions can be accessed in numerous ways or through any of the modes or views. In the illustrative example of FIG. 24, these functions have been accessed by selecting the “Menu” icon 202, whereupon a pop up box 194 containing a list of the functions appears. The user then can select the desired function. Other ways to access functions are within the method.

In the illustrative example of FIG. 24, the method has provided a “Create New Display” 199 in the menu that was spawned by selecting the “Menu” icon 202. Selecting this function will trigger the system to create a new information display. This and other functions can be included either in a module box, on a task or softkey bar or by any other method.

The method can also provide a user with the ability to open previous draft information displays, save displays, publish the new display and save the whole display as a template within an information display gallery. Numerous techniques can be used to carry out these functions within the method.

In the illustrative example of FIG. 24, the user can select the “Save display” function 195 to save any changes made to the information display. A user will be able to save the information display to a list or folder so it can be used as a template to create additional information displays with a similar appearance. In an embodiment of the method, the user can save using a text label or any identifying label. In an embodiment the user can create or save the template as an icon representing the information display for easy recognition when selecting a template. Preferably, the icon will relate to the template information display in some way to allow easy recognition of the template information display when viewed by a user. In the illustrative example of FIG. 24, the user can select the “Save to Gallery” button 196 to save the template to a My Gallery folder or list. In one embodiment when the same template exists with the same name, the method will create a new version of the template. In an embodiment of the method when a user selects “Save to Gallery,” it will open a sliding form that will request the Name and Icon or other identifying indicia for that template.

As stated above, the method can provide other functions whether in module box as in the example of FIG. 24 or accessed by other known ways. One such function can be “Save and Publish” 197. Publishing an information display will allow the user to publish this information display as a live display and override the existing display. It will default to the same location as was chosen when the User created the information display. Preferably, when the “Publish display” function 198 is selected, it will bring up a prompt, “Changes will be updated and will override the current information display” “Continue/Cancel.” Another function that can be provided in the method is a technique to open an existing saved information display. The user selects this function and preferably a list of saved information displays appear for example, in a list, folder or module box. The user then chooses the information display to open and the method implements the user's choice. In one embodiment of the method when the user selects the open information display function a module box appears that displays a list of saved information displays by name, icon, version or any identifying way.

The method can provide techniques that will allow a user to search for previously created information displays and to open such information displays. Once an information display is opened the user can modify the information display or publish it. There are numerous techniques for searching, accessing and displaying a list of information displays as well as for selecting an information display that are known by a person of skill in the art.

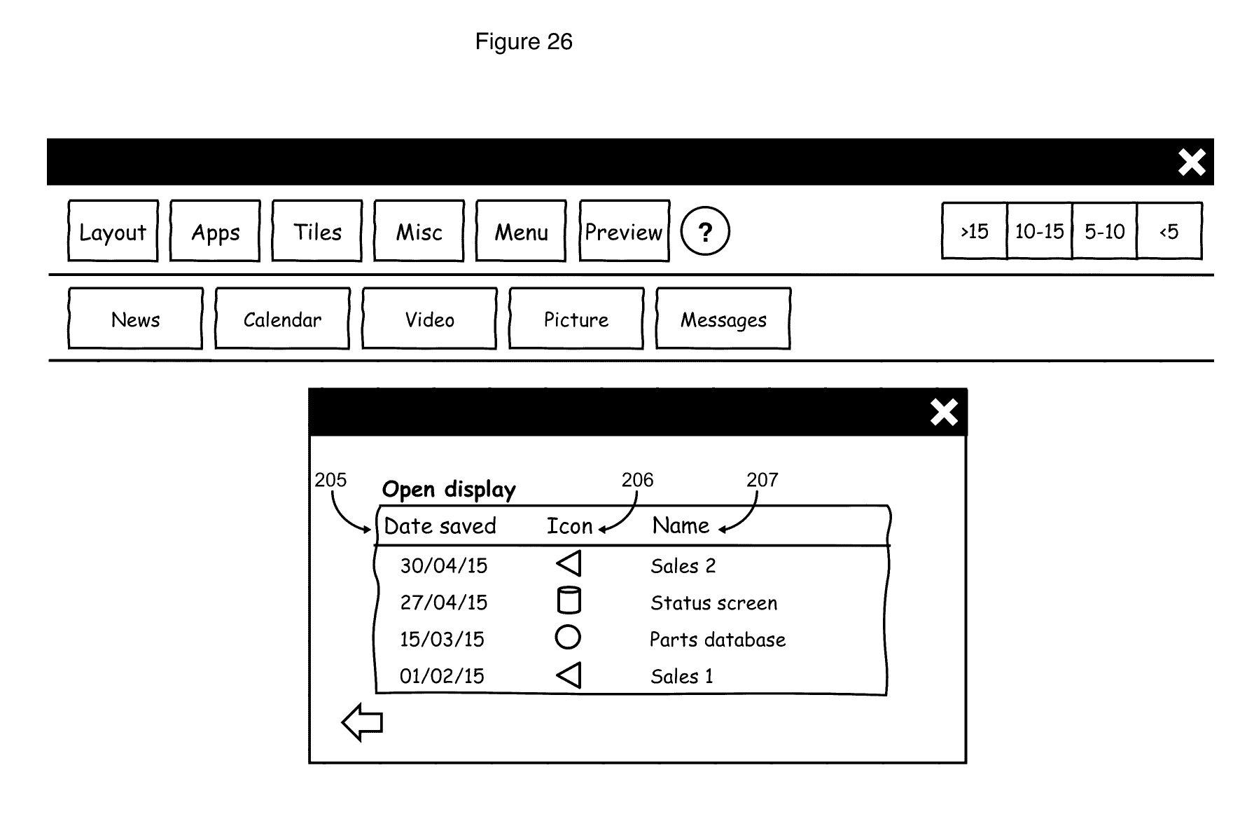

FIG. 26 illustrates the design canvas as seen when the user has selected the “Open Display” option 201 illustrated in FIG. 24. In this example, a module box appeared on top of the design canvas with a list of saved information displays. In the illustrative example of FIG. 26, each saved information display is listed by the save date 205, icon 206, and name 207. Other ways to show saved information displays are certainly contemplated as within the method. When a saved information display is selected, it will open that information display. In the illustrative example, the information display is opened in the edit/design canvas mode.

The user can perform the necessary functions to this information display including edit, and publish the information display. In this illustrated example, the user can select the desired information display to open by selecting the radio button associated with the desired information display.

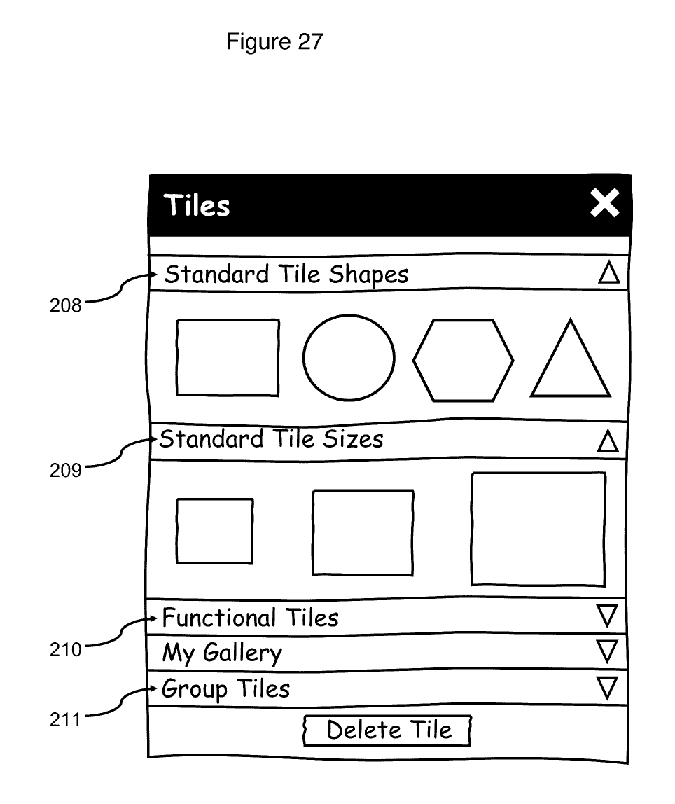

FIG. 27 illustrates a blow up view of the Tile Menu 187 from the illustrative example of FIG. 23. As previously stated, the use of a module box or area containing tiles ready to be selected of dragged into the design canvas is just one embodiment of the method to make an information display. Other techniques are contemplated that are within the invention set forth herein. In the embodiment of FIG. 27, the Tile Menu contains several selectable folders, tabs or components, including Functional Tiles 210 and Group Tiles 211. In FIG. 27 the Standard Tile Shapes 208 and Standard Tile Sizes 209 folders or components have been selected causing them to expand to show, in this example, standard tiles that a user in this example can quickly drag onto the design canvas. Other embodiments may have different numbers or kinds of standard tiles or may not contain any standard tiles.

Alternatively, the numbers or kinds of standard tiles may be linked to a particular theme or other attribute of the intended information display. For example, the method can provide a technique for the user to assign an information display with a theme, title or other attribute to the information display at creation or at a later time. In the illustrative example of FIG. 22, the user was prompted 184 to pick a color theme. The method can further provide a technique for changing the theme, title or other attribute to the information display. Each theme can contain numerous attributes or characteristics such as color schemes.

Further, tile attributes or characteristics can be assigned to a theme, title or other attribute to the information display so that these attributes or characteristics will be automatically presented when the theme, title or other attribute to the information display is selected. Attributes or characteristics may include color, shape, size or tile functionality.

In an embodiment of the method when the user selects the theme upon setting up the information display or if the theme is changed the standard tiles will reflect that theme, title or other attribute to the information display. For example, in one particular embodiment if the user selects a certain theme upon setting up the information display, or if the theme is changed, the standard tiles will use the colors from the theme. In a further embodiment, if the theme contains three main colors, the method can provide three standard tiles, all using one of the three main colors. In another embodiment, if the theme contains three main colors, the method can provide three standard tiles, each using a different one of the three main colors.

The workspace can support a variety of tile types, including standard tiles and functional tiles. Standard tiles have no link to content or other applications, either local or remote. Standard tiles can be blank, or can include static text, images, or graphics.

The functional tiles can include a list of functions that a user can add onto the design canvas. Some functional tiles may be more configurable than others, but will have specific functionality and can be of all different sizes. Functional tiles can be arranged in numerous different ways.

Functional tiles can display or represent content provided or maintained by a software application local to the AR/VR display device, or remote to the device. For example, the AR/VR display device can include a contact software application that maintains a list of contacts with associated contact cards. Contacts are generally individuals or entities and contact cards generally include information associated with a contact (e.g., name, title, telephone number, email address, physical address and the like). A functional tile can act as a shortcut to a contact card included in the contact list maintained by the contact software application on the AR/VR display device. If the functional tile is a background tile, the thumbnail view can include an image of the contact, text or any other information regarding the contact. The functional tile can include a context indicator for the contact. The context indicator can show the current state of the contact such as whether the contact is online, the contact's location or any other property of the contact. In summary or background view the functional tile for the contact can include graphics, text and any other information associated with the contact.

A functional tile can also provide the user with the ability to launch a software application associated with the functional tile. Users can view limited functional information from a background tile. Users can view additional functional information using the summary view. However, the user may wish to perform additional functions, such as updating the contact card. The functional tile can provide a user with the ability to launch the full contact application directly from the tile, without requiring the user to navigate to a menu of available applications.

Functional tiles can host controls with which the user can interact to preclude requiring the user to navigate away from the tile space to an application. For example, a functional tile can provide a simple messaging function, or display stories from a particular newspaper.

Functional tiles can also have links in them or contain audio or video embedded in them. Functional tiles can be retrieved or obtained from a remote source, such as a server. Vendors of services or data can generate and offer tiles to users. Functional tiles can obtain a variety of functions from remote sources. For instance, a user may subscribe to a news service. A tile can display a subset of news provided by the news service and/or as well as an indication of important news bulletins. In a further example, a tile can provide a user with rapid access to one or more maps frequently utilized by the user. Typically, geographic data sets such as maps are large.

Vendors can provide tiles to users as a service. Users can be required to subscribe to the service to obtain the desired functionality. Alternatively, vendors can provide tiles to users to perform targeted advertising.

Functional tiles can also provide the ability to directly access an associated remote service without having to navigate to a menu of applications.

A functional tile can also provide a user with quick, direct access to an application. Activation of the tile launches the associated application without requiring a user to navigate to a list of applications to search and select the desired application. For instance, a functional tile can provide a link to a game or other application. Thumbnail and summary views for functional tiles can include graphics, text or other suitable visual cues to allow a user to easily identify the application.

The tile space can also include shortcut tiles. Shortcut tiles can provide shortcuts or links to any other location in the AR/VR environment. For example, the AR/VR environment can include another user interface for navigating functions particular to that environment. Users can utilize a shortcut tile to leave the tile space and navigate to the alternate end user interface.

Functional tiles can also link to forms, other documents, images, or other content saved either locally or remotely. A functional tile may also contain navigation functions to assist the user to navigate around the information display

Tiles can include any combination of text, graphic images, hyperlinks or any other visual representation in both summary view and thumbnail view. Further, an image can be used as the background of the tile with text overlaying the image. Each individual tile can include multiple cells or columns that can be populated with data of varying data types. For instance, a messaging tile can include a column or cell for an icon that can reflect the method of communication (e.g., voicemail or text message), a cell for text including the message, and a cell for text including the sender name. Different columns or cells can have separate tasks associated with the individual columns or cells. Accordingly, selection of an icon within a tile can generate different task options than selection of the text in the same tile. In addition, tiles can include audio cues or data. For example, audio data may be triggered when a tile is active or selected.

The method can provide other types of tiles in information displays for an AR/VR environment.

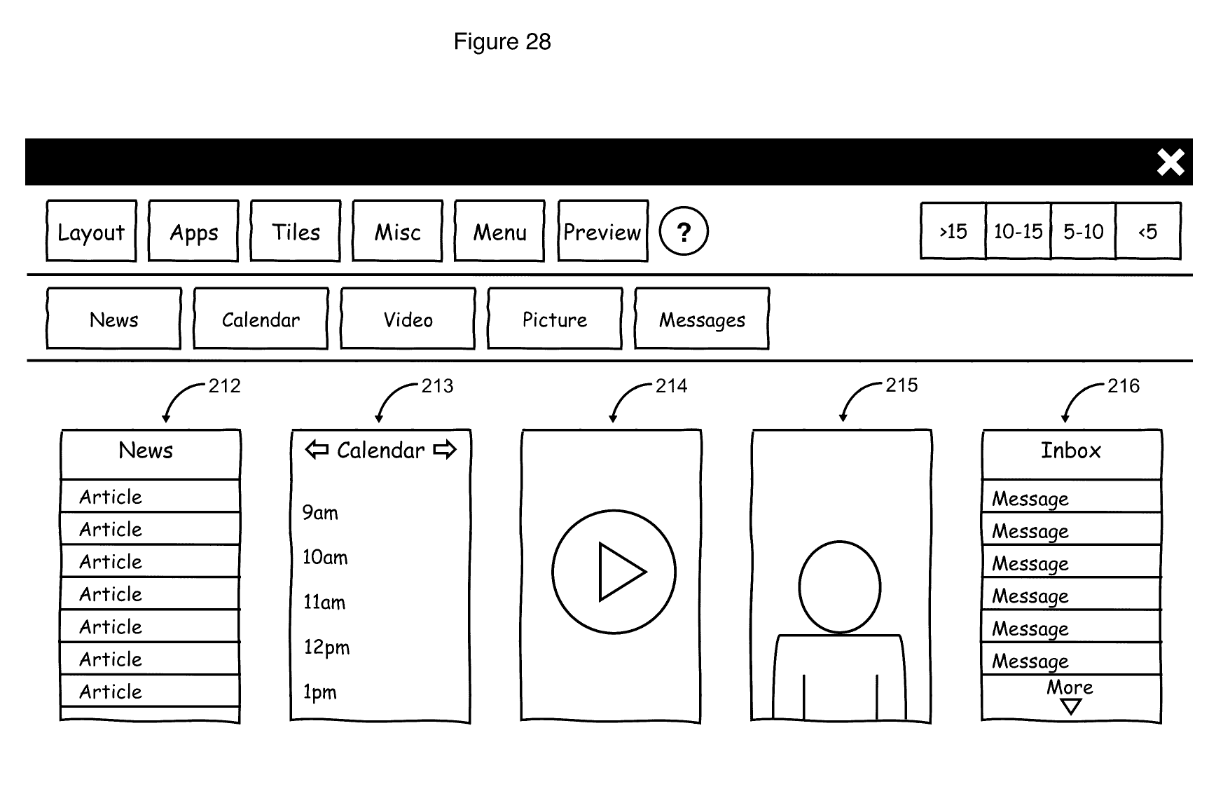

FIG. 28 illustrates examples of functional tiles in a design canvas. In this example, the functional tiles include: News 212, Calendar 213, Video 214, Picture 215, and Messages 216.

Functional tiles can be added using the same technique as with adding standard tiles, or by any technique. Examples include selecting from a list, menu or tab containing functional tiles. In the illustrative example of FIG. 27, the Functional Tiles 210 option is contained on the Tile Menu module box. Once selected, a list of possible functional tiles can appear. The list can be delineated by name, icon or any identifying method. A particular functional tile can be selected and a position for the functional tile can be selected in the design canvas. In one embodiment of the method an input device can be used to select, drag and drop the functional tile into the design canvas. In another embodiment of the method, the functional tiles can be represented by a name or icon, which can be dragged into the design canvas. Upon dropping the name or icon at the desired position in the design canvas, the corresponding functional tile, or icon of this tile, expands to its active size.

The method can provide techniques to allow a user to group or link two or more tiles together and save them as a group. Groups can be based upon certain characteristics or metadata. For example, some tiles might contain similar attributes or relationship, and a user would want these tiles to be grouped together. Further, the method can provide techniques that will keep grouped tiles together when moved by the user. The method can provide other techniques for linking two or more tiles whether the tiles are adjacent to each other or not. The method can provide techniques to list and retrieve grouped tiles. In one illustrative embodiment of the invention depicted in FIG. 27 the listing of the Group Tiles 211 is contained on the Tile Menu. However, any known technique for assessing Group Tiles, if included in the responsive display, can be used.

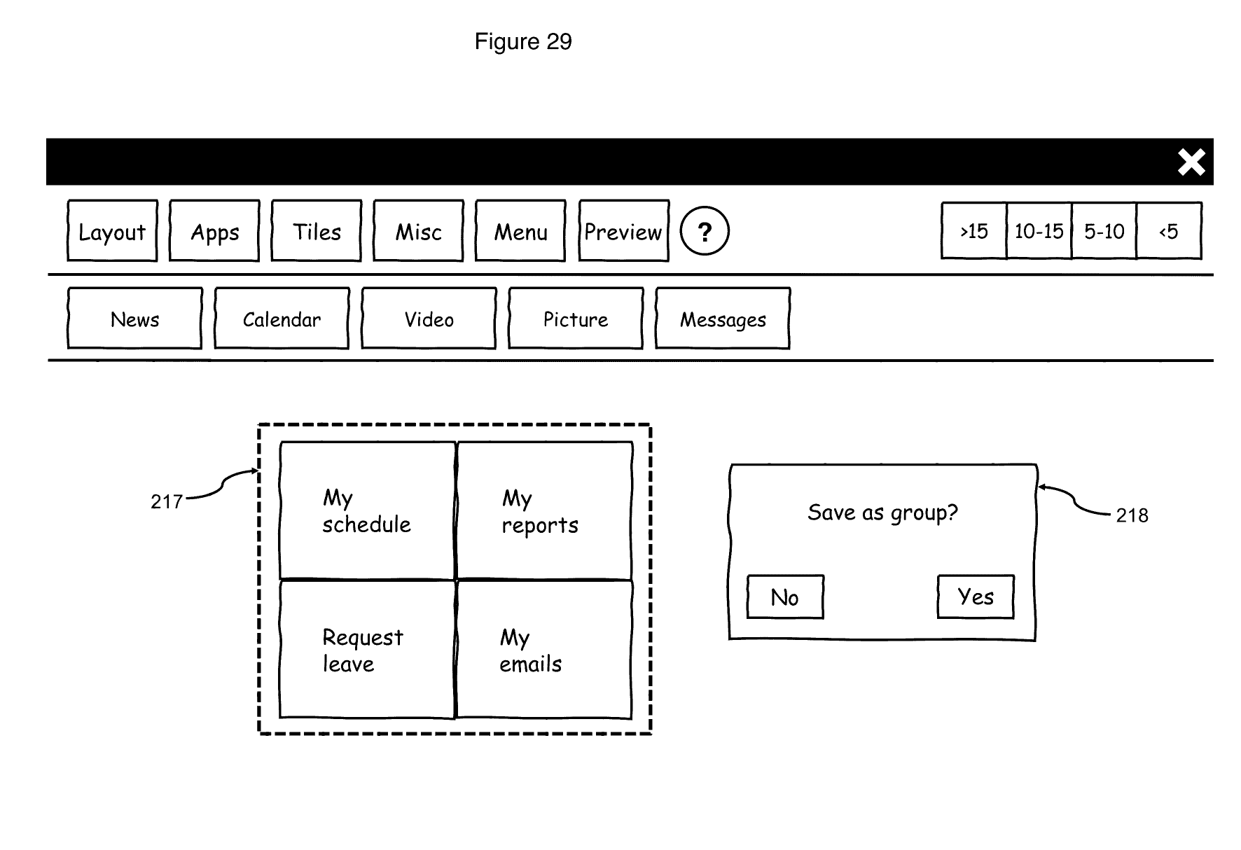

FIG. 29 illustrates the concept of “group tiles” in an illustrative embodiment of the invention. In this embodiment, “group tiles” can allow a user to group a set of tiles together, and save all of the properties including the spacing and color so that they can be easily dragged onto the design canvas as a group. In this example, a group of adjacent tiles have been selected to form a group. Selection can be in any known way, including making a box around the desired tiles using an input device, or by highlighting adjacent tiles by selecting them. Either automatically or by user action, an option, icon or pop up box may appear containing the function of saving the desired group of tiles as a tile group.

In the example in FIG. 29 the user can create a group of tiles using a mouse, or other input device such as a touch screen gesture or AR/VR control gesture, to select a set of tiles 217. When selected, the techniques can provide an option to appear, such as Save as Group 218. In an embodiment of the method selecting this option may result in a module box appearing with the ability to enter the identifying indicia for this group such as group name or group icon. An option in the module box can allow the user to save the group with the identifying indicia entered by the user.

Moreover, the method can provide a technique to allow the user to move and drop the tiles as a group. The method can also provide a search feature that will allow a user to search for a tile or a group of tiles by name or label. The search feature can be contained in any part of the design canvas, including one of more of the task bars, the Tile Menu, or the Group Tiles folder, component or tab.

The method can provide for techniques to allow a user to label a tile or a group of tiles with text, icons, or other identifying markers. Labels can be associated with a tile or a group of tiles in numerous ways. For example, a label such as text can be inserted within the tile by using an input device such as by typing text or dragging text. Alternatively, each tile or group of tiles may contain a label box within the tile or group of tiles or accompanying the tile or group of tiles. Alternatively, the label may be on the design canvas either near the tile or group of tiles or somehow associated with the tile or group of tiles.

The method can provide techniques to assist a user in selecting and placing selected tiles or groups of tiles in the design canvas from a reservoir of tiles or from the design canvas. For example, once selected tiles or groups of tiles can expand or contract, or all or part of the tile or group of tile can change color indicating the tiles selected. When the user selects and indicates the desired placement of these tiles in the design canvas by, for example, dropping the tile or group of tiles, the tile or group of tiles then revert back to the default characteristics. In one embodiment of the invention, when a tile such as a functional tile is selected and dragged from where it resides, such as in a tab on the Tile Menu, the tile or group of tiles shrinks to prevent the tile from obscuring the design canvas. This allows the user to better position the tile at the desired location in the design canvas. Upon employing the drop function, the tile or group of tiles expands back to the desired size. Alternatively, the tile itself may be represented only by an icon, name or other identifier in the tile list or tab and not the actual active tile. This representation of the tile then can be selected and placed in the design canvas whereupon it becomes the actual working tile.

The method can also provide techniques that will allow a user to set various parameters for a tile or a group of tiles. Such parameters may include title, icon, height, width and color, although many other parameters can be included.

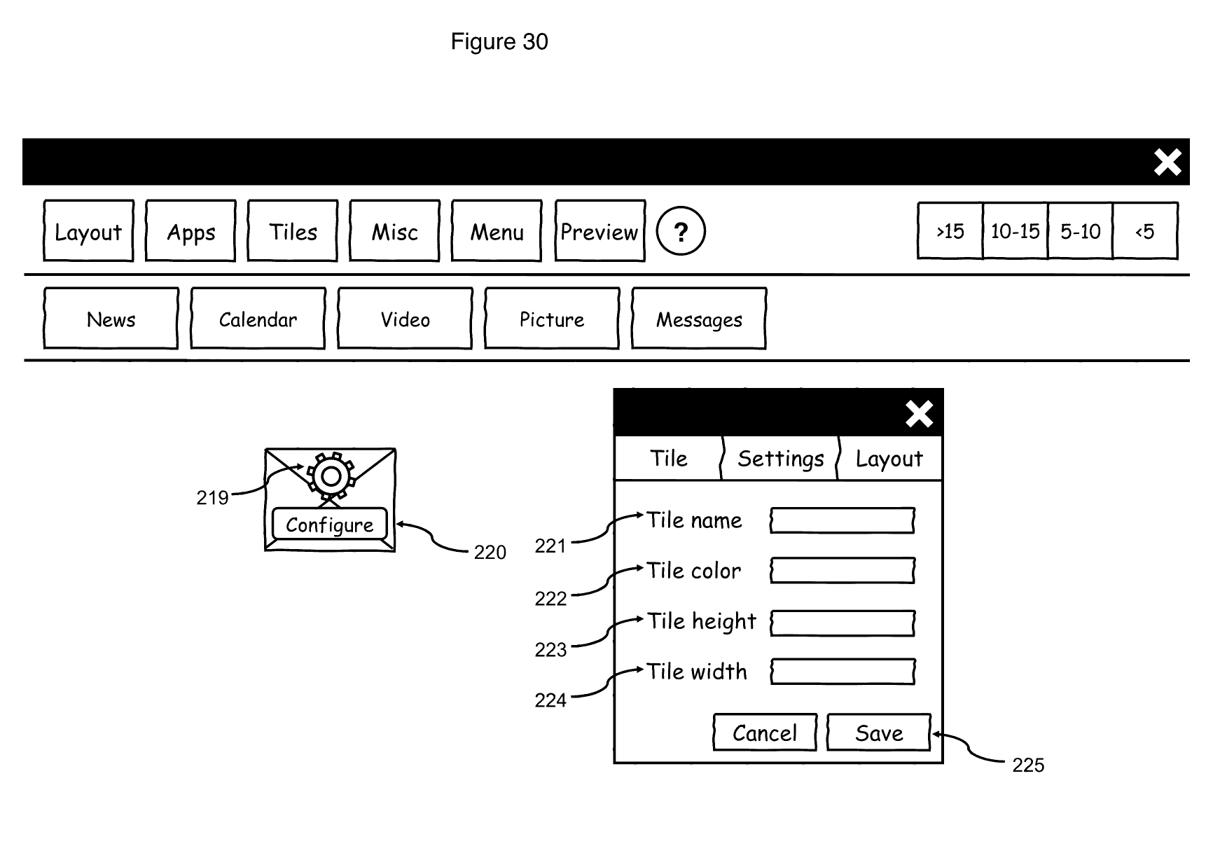

FIG. 30 illustrates Tile Configuration, which is a possible function that is within the method. When a tile or a group of tiles is placed or moved on the design canvas or after being moved the method can employ either automatically or through user action a technique to configure the tile or a group of tiles that was just placed on the design canvas. Configuration allows the user to change one or more characteristics of the tile or group of tiles. Numerous possible characteristics may be configured, including tile name, tile color, tile height, tile width, title position, title size, or other characteristics.

In the illustrative example of FIG. 30, when the tile 219 was selected and placed by dragging it onto the design canvas from the Tile Menu, a Configure icon 220 automatically appeared. In this example, selecting this icon will cause a module box to appear containing one or more configuration settings. Possible configuration settings include tile name 221, tile color 222, tile height 223, and tile width 224. The user then inputs the desired configuration parameters for each setting through any input means. When the user is finished entering the configuration parameters the method allows the user to save and implement the function. In the example of FIG. 30, the user saves the settings by selecting the Save function 225.

Other techniques can be employed for a user to configure a tile or group of tiles. For example, the configuration function can be accessed through a taskbar or softkey bar contained on the design canvas or on the tile itself. These softkey bars may be visible at all times or appear only through user action. In addition, the configuration function can be in a separate mode or view of accessible in any view or mode.

The method can be employed on any computing device capable of running a software application including a desktop computer, a laptop computer, a tablet computer, a smart phone, a set-top box, a smart television, a gaming device, or an AR/VR display device.

### CONCLUSION

This system and method will aid users in creating, sleek, seamless and responsive designs that will invariably lead to AR/VR environments having higher adoption rates. It provides a user-friendly experience in:
1. Creating information displays, and choosing templates for the responsive design of the information displays and their appearance at various apparent distances when in the AR/VR environment.
2. Utilizing the design canvas to drag and drop tiles.
3. Choosing from a large selection of templates for different apparent distances.
4. Grouping tiles together, increasing efficiency, customization and responsiveness.
5. Configuring content containers for optimum customization.
6. Allowing users who are unfamiliar with coding and AR/VR design the tools needed to create responsive information displays for AR/VR environments using a drag and drop interface, without requiring knowledge of coding or programming

1. A computer-implemented method for creating responsive design information displays for implementation in an augmented reality or virtual reality environment comprising:
displaying an user interface page configured to accept rows, containers, or content;
accepting inputs from user for one or more containers or rows;
accepting from the user content for such containers or rows;
retrieving code corresponding to the inputs from the user.

2. The method of claim 1 further including a step of implementing the information display in an augmented reality or virtual reality environment.

3. The method of claim 1 further including a step of accepting inputs from the user to modify the attributes of the rows, containers, or content.

4. The method of claim 1 wherein the content is dynamic.

5. The method of claim 1 wherein a responsive parameter is the proximity of the end-user to the information display in an augmented reality or virtual reality environment.

6. The method of claim 1 wherein the code is retrieved from a UI Component.

7. The method of claim 5 wherein the UI Component comprises a proximity responsive ruleset, a visual design settings, and a data/content connection settings.

8. A computer program product for creating a custom user interface for an application using one or more natural language statements residing on a non-transitory computer-readable storage medium having a plurality of instructions stored thereon, which, when executed by a processor, cause the processor to perform operations comprising:
displaying an user interface page configured to accept rows, containers, or content;
accepting inputs from user for one or more containers or rows;
accepting from the user content for such containers or rows;
accepting inputs from the user for one or more responsive parameters; and
retrieving code corresponding to the inputs from the user.

9. The computer program product of claim 8 wherein the product is implemented in an augmented reality or virtual reality environment.

10. The computer program product of claim 8 wherein a responsive parameter is the proximity of the end-user to the information display in an augmented reality or virtual reality environment.

11. A computer system comprising:
one or more processor devices; and
one or more memory architectures coupled with the one or more processor devices;
wherein the one or more processor devices are configured to:
display an user interface page configured to accept rows, containers, or content;
accept inputs from user for one or more containers or rows;
accept from the user content for such containers or rows;
accept inputs from the user for one or more responsive parameters; and
retrieve code corresponding to the inputs from the user.

12. The computer system of claim 11 wherein the responsive parameter is the proximity of the end-user to the information display in an augmented reality or virtual reality environment.

13. The computer system of claim 11 further comprising a UI Component.

14. The computer system of claim 11 wherein the code is retrieved from the UI component

15. The computer system of claim 11 wherein the UI Component comprises a proximity responsive ruleset, a visual design settings, and a data/content connection settings.

16. An augmented reality or virtual reality (AR/VR) system comprising:
an AR/VR platform containing a display application running thereon and presenting information to the user and/or end user within the AR/VR environment, as well as receiving control inputs from the user and/or data from the AR/VR software;
one or more responsive information displays in the AR/VR environment wherein the one or more of the information displays dynamically adjusts.

17. The system of claim 16 wherein the information adjusts based upon defined configuration ruleset.

18. The system of claim 16 wherein the information adjusts based upon the proximity of the end-user to the information display.

19. A computer implemented method for adjusting one or more information displays functioning within an AR/VR environment comprising:
receiving data from the AR/VR environment regarding one or more parameters;
comparing one or more parameters to previously defined parameters;
sending data to the AR/VR environment to adjust the configuration of the one or more information displays.

20. The computer implemented method of claim 19 further comprising displaying the adjusted one or more information displays in the AR/VR environment.

21. The computer implemented method of claim 19 wherein one or more parameters comprises the proximity of the end of the end user to the one or more information displays.
